(19) United States
(12) Patent Application Publication
(10) Pub. No.: US 2005/0218222 A1
(43) Pub. Date: Oct. 6, 2005

(54) Universal identifier systems in supply chain logistics

(75) Inventors: David N. Nark, Alpharetta, GA (US); Robert J. Gillen, Alpharetta, GA (US); Mark Horton, Suwanee, GA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 11/099,167

(22) Filed: Apr. 4, 2005

Related U.S. Application Data
(60) Provisional application No. 60/559,080, filed on Apr. 2, 2004.

(51) Int. Cl. G07B 15/02

(52) U.S. Cl. 235/384

(57) ABSTRACT

The present invention is generally directed to systems and methods to provide a user with visibility to certain packages that are transported by one or more carriers and that have a universal identifier included in each package's package level detail information. The universal identifier may be used to access the package level detail information in each package by the parties to a shipping transaction and by third-parties that are not the shipper, recipient or intended recipient of the packages.

### CROSS-REFERENCE TO RELATED APPLICATIONS

This application claims the benefit of U.S. Provisional Application No. 60/559,080, filed Apr. 2, 2004.

### BACKGROUND OF THE INVENTION

1. Field of the Invention

The present invention provides systems for delivering aggregated information based services without the use of singular package tracking numbers. Notification systems and processes are disclosed for updating a user with package information.

2. Description of Related Art

Package tracking is an integral part of a package delivery service that allows a customer to track goods or items that they have shipped, that have been shipped to them, or that are currently in shipment to them. The advent of the Internet has allowed commercial carriers such as United Parcel Service (UPS) to make it possible for customers to track their shipments online. Some businesses have taken package tracking a step further and integrated the package tracking functionality into their internal business systems. Thus, businesses have the ability to trigger business events based upon shipment status information received from a commercial carrier.

For the most part, package tracking services operate on a package by package basis and require that a customer query a carrier database with a package tracking number associated with the package to be tracked. As a result, it is difficult for a company with a heavy volume of inbound or outbound shipping to track all its packages currently in transit. Companies are often stuck with the burdensome task of individually tracking large numbers of packages or risk being surprised when an abnormally large number of packages arrive at their loading docks with insufficient help to dispatch them.

An unsatisfied need therefore exists in the industry for package tracking methods and systems that overcomes this and other challenges.

### BRIEF SUMMARY OF THE INVENTION

The present invention is generally directed to systems and methods to provide one or more users with visibility to packages that are inbound to and/or outbound from one or more users. The one or more users may be parties to a shipping transaction (e.g., carriers, shippers and/or recipients), or third parties (whether having an interest in the transaction or not). Various embodiments of the invention further describe a subscription system that allows the user to determine the frequency and format of package visibility information, and various tools are disclosed to automate and customize the presentation of package visibility information to the user.

A carrier having a package visibility system has as a component of that system a universal identifier, hereafter a UID. The UID is an identifier that is included in package information. The UID provides a method by which shippers, consignees and third parties can track shipments without having or knowing individual package tracking numbers. A user may be associated with one or more UIDs and the UIDs may in some instances have a hierarchical relation to one another (i.e., one UID may be assigned to another UID). A UID may be included in the package information of packages that are not inbound to or outbound from the particular user that has been assigned the UID to allow the UID-holder to track or obtain information about such packages. A UID may be assigned to a specific user, company or companies, product lines, websites, IP addresses, URL addresses, departments, locations, subsidiaries, etc. As described in greater detail herein, in various embodiments a UID coupled with user-specific information provides authorization that allows select users to receive package information about the packages that are associated with the UID. This package information may include, for example, information about inbound, outbound, freight collect, third-party billed, consignee billed, and other alternate billing arrangements. Furthermore, a UID coupled with user-specific information may, with the proper authorization, allow the user to add, delete, modify or change select package information and modify the business rules of the carrier, recipient and shipper that are associated with the delivery of the certain packages, depending upon the level of authorization provided to the UID-holder.

In accordance with one embodiment of the invention, a system for tracking packages shipped via a carrier is described that is comprised of a package visibility front-end that communicates with an interface over a network, a visibility engine that communicates with the package visibility front-end. The visibility engine is configured to capture user information from the interface, provide a tracking notification to one or more users, process user information and package-tracking information, and communicate with at least one of the carrier's, a vendor's or said one or more user's systems. The system also includes one or more carrier databases and at least one of a subscription database or a package visibility database. The subscription database is a database where at least user and account administration data is stored and the package visibility database is a storage area where at least information about inbound and outbound packages to the one or more users is stored. The one or more carrier databases store at least package level detail information about packages in transit, where the package level detail information includes one or more universal identifiers that may be assigned to one or more packages. The system receives at least one valid universal identifier via the interface as a portion of the user information and the system and provides at least a portion of the package level detail information about one or more packages associated with the valid universal identifier received via the interface.

In accordance with another embodiment of the system, a system for tracking one or more packages is described that is comprised of an on-line transactions module accessible via an on-line transactions website via the Internet by one or more buyers and one or more sellers to conduct buy/sell transactions. The buy/sell transactions comprise sellers offering items for sale under a set of seller rules and buyers that may buy the items under a set of buyer rules and shipping transactions via one or more carriers for items sold by a buyer to a seller may be arranged through the on-line transactions website for a selected carrier. The system is further comprised of a universal identification module where shipping transactions that are arranged through the on-line transactions website have at least one unique universal identifier associated with the on-line transactions website that is assigned to package level detail information maintained by the selected carrier for each package shipped from the seller subsequent to said buy/sell transactions. A tracking and reporting module is also described as part of the system where each package shipped via the selected carrier and having the unique universal identifier is tracked and a status for each package is reported to an authorized operator of the on-line transactions website having knowledge of the unique universal identifier.

In accordance with another embodiment of the present invention, a universal identifier used in the shipment of one or more packages via a carrier is described. The universal identifier is comprised of a string of alphabetical, numeric, and/or alphanumeric characters and/or symbols of varying length that may be encoded into a machine-readable format. The universal identifier is included in one or more packages' package level detail information as such package information is maintained by a carrier transporting the one or more packages and where the universal identifier may be used to obtain at least a portion of the package level detail information about the one or more packages regardless of the location the one or more packages are shipped to or from, a shipper, or a recipient.

In accordance with another embodiment of the present invention, a system for tracking packages having one or more universal identifiers is described. The system is comprised of at least one carrier database that stores package information about one or more packages that are in transit in a carrier system. The package information includes the universal identifier associated with each package. The system is further comprised of a visibility engine in communication with the carrier database. The visibility engine is configured to review the package information and to identify the one or more packages having a certain universal identifier. A user computer is also described that is in communication with the visibility engine via a network. The user computer is configured to receive shipping information associated with the one or more packages having the certain universal identifier, including at least a portion of the package information. In one aspect of the system of this embodiment, the unique universal identifier is assigned to shipping transactions involving the one or more packages shipped from a single shipping entity or multiple shipping entities to a single receiver entity or multiple receiver entities. The universal identifier provides access to information about the shipping transactions involving the single or multiple entities and the universal identifier is unrelated to the physical movement or location of the one or more packages, shipping entities and receiving entities. In another aspect of the system of this embodiment, the universal identifier may be used for providing multiple visibility and shipment options to a third party that is unrelated to the physical movement of the certain packages in a supply chain. Another aspect of the system of this embodiment is where the universal identifier allows a third party to view, monitor and change business rules governing the physical movement transactions between multiple other shippers and recipient parties. In yet another aspect of the system of this embodiment, the universal identifier is used by the carrier to notify one or more certain parties of state changes of certain of the one or more packages where the certain parties are associated with the universal identifier and where the business rules of the certain parties provide for the certain parties to react to state changes of certain of the one or more packages by either no action, manually modifying the package information or business rules for delivery of the certain one or more packages, or automatically modifying the package information or business rules for delivery of the certain one or more packages, or any combination thereof.

In accordance with another embodiment of the present invention, a system that allows a first user to receive information about one or more packages that are inbound and outbound via a carrier from users other than the first user is described. The system is comprised of a carrier database that stores shipping information for packages that are in transit in a carrier system and a visibility engine in communication with the carrier database. The visibility engine is configured to create an inbound subscription and an outbound subscription for the first user where each subscription contains at least one universal identifier. The system also includes a first user computer in communication with the visibility engine where the visibility engine is further configured to provide at least a portion of the shipping information for packages having at least one of the universal identifiers in their shipping information to the first user via the first user computer in accordance with the inbound or the outbound subscriptions. In one aspect, in the system of this embodiment the inbound subscription specifies at least one universal identifier that is associated with the first user and the visibility engine is configured to identify packages that are inbound to users other than first user by comparing the at least one universal identifier against the shipping information, and the outbound subscription specifies the universal identifier associated with the first user, and the visibility engine is configured to identify packages that are outbound from users other than the first user by comparing the universal identifier against the shipping information. The visibility engine is further configured to provide at least a portion of the shipping information for packages to the first user via the first user computer for packages inbound to and packages outbound from users other than the first user with a frequency specified in the inbound or the outbound subscriptions.

In another aspect of the embodiment of the system described above, the inbound subscription specifies at least one universal identifier that is associated with the first user, and the visibility engine is configured to identify packages that are inbound to the first user and one or more other users by comparing the at least one universal identifier against the shipping information and the outbound subscription specifies the universal identifier associated with the first user and the visibility engine is configured to identify packages that are outbound from the first user and the one or more other users by comparing the universal identifier against the shipping information. The visibility engine is further configured to provide at least a portion of the shipping information for packages to the first user via the first user computer for packages inbound to and packages outbound from the first user and the one or more other users in a format specified in the inbound or the outbound subscriptions.

In another aspect of the embodiment of the system described above, the inbound and outbound subscription specifies at least one universal identifier that is associated with the first user and the visibility engine is configured to identify packages that are inbound to and outbound from the first user by comparing the at least one universal identifier against the shipping information. The visibility engine is further configured to provide at least a portion of the shipping information for packages to the first user via the first user computer for packages inbound to and packages outbound from the first user with a frequency specified in the inbound and outbound subscription. In yet another aspect of the embodiment of the system described above, the inbound and outbound subscriptions specify a master universal identifier and at least one universal identifier that is in a hierarchical relation to the master universal identifier. The master universal identifier and the at least one universal identifier are associated with the first user and the visibility engine is configured to identify packages that are inbound to and outbound from the first user by comparing the master universal identifier and the at least one universal identifier against the shipping information. The visibility engine is further configured to provide at least a portion of the shipping information for packages to the first user via the first user computer for packages inbound to and packages outbound from the first user with such information sorted by the at least one universal identifier and with a frequency specified in the subscription.

In another aspect of the embodiment of the system described above, the inbound and outbound subscription specifies a master universal identifier and a plurality of universal identifiers that are each in a hierarchical relation to the master universal identifier. The master universal identifier and the plurality of universal identifiers are associated with the first user and the visibility engine is configured to identify packages that are inbound to and outbound from the first user by comparing the master universal identifier and the plurality of universal identifiers against the shipping information. The visibility engine is further configured to provide at least a portion of the shipping information for packages to the first user via the first user computer for packages inbound to and packages outbound from the first user with such information sorted by the plurality of universal identifiers and with a frequency specified in the subscription.

These and other embodiments and aspects of the present invention are described herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1a and 1b illustrate embodiments of computers that can be used to practice aspects of the present invention, in various embodiments;

FIG. 2 is a high-level block diagram of a visibility package system in accordance with an embodiment of the present invention;

FIG. 3 is a process flow diagram that illustrates the steps used to create a visibility subscription;

FIGS. 4A and 4B show a web page that captures subscription information from a user;

FIGS. 5A-5C show web pages that capture additional subscription information from a user;

FIGS. 6A and 6B show a web page that illustrates some of the methods of associating a carrier account with an outbound subscription;

FIG. 7 is a process flow diagram that illustrates the steps used to create a universal identifier;

FIG. 8 is a process flow diagram that illustrates the steps used to establish a corporate administrator;

FIG. 9 is a process flow diagram that illustrates the steps used to establish a sub-administrator;

FIG. 10 is an illustrative system diagram for the use of one or more UIDs with an on-line marketplace, in an embodiment of the invention;

FIG. 11 is a process flow diagram that illustrates the steps used to report package information about packages having a certain one or more UIDs in their PLD to an on-line marketplace, in an embodiment of the invention;

FIG. 12 is an illustrative system diagram for the use of one or more UIDs with an on-line aggregator, in an embodiment of the invention;

FIG. 13 is a process flow diagram that illustrates the steps used to report package information about packages having a certain one or more UIDs in their PLD to an on-line aggregator, in an embodiment of the invention;

FIG. 14 is an exemplary large manufacturer that has several sub-entities and illustrates a hierarchical or parent-child relationship of one or more UIDs assigned to sub-entities to a parent entity, in an embodiment of the invention;

FIG. 15 is a process flow diagram that illustrates the steps used to report package information about packages having a certain one or more sub-entity UIDs in their PLD that are in a hierarchical relationship to a master UID, in an embodiment of the invention;

FIG. 16 is a system diagram that shows the communication between an XML online tool and various backend applications of a package visibility system in accordance with an embodiment of the present invention;

FIG. 17 is a process flow diagram that illustrates how a XML request is processed;

FIG. 18 is a process flow diagram that illustrates the steps used to install and configure an autoload application; and

FIG. 19 illustrates a proactive notification tool in accordance with an embodiment of the present invention.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Overview

An inbound and outbound package visibility tracking system (hereafter a package visibility system) is described herein that allows a commercial carrier such as UPS to identify those packages that are in transit, either to or from one or more particular users. In one embodiment, tracking notifications are created by the carrier and delivered to users via one or more notification systems that are described herein. In one embodiment, these notifications provide package level detail (PLD) information to users. Such PLD information includes destination and origin shipment information, and in-transit, exception and delivery data, etc. In other disclosed embodiments, additional notification data is provided to users including, without limitation, delivery date and delivery time, delivery address, reference number, cash-on-delivery (COD) amount and a signature image. In some instances, users may be authorized to change, modify, add or delete package information or business rules of the carrier associated with the delivery of certain packages.

A component of the package visibility system is a universal identifier, hereafter a UID. The UID is an identifier that is included in PLD information. The UID provides a method by which shippers, consignees and third parties can track shipments without having or knowing individual package tracking numbers. A user may be associated with one or more UIDs and the UIDs may in some instances have a hierarchical relation to one another. A UID may be included in the PLD information of packages that are not inbound to or outbound from the particular user that has been assigned the UID. A UID may be assigned to a specific user, company or companies, product lines, websites, IP addresses, URL addresses, departments, locations, subsidiaries, another UID, etc. As described in greater detail below, a UID coupled with user-specific information allows select users to receive package information about the packages that are associated with the UID. This package information may include, for example, information about inbound, outbound, freight collect, third-party billed, consignee billed, and other alternate billing arrangements. Furthermore, a UID coupled with user-specific information may, with the proper authorization, allow the user to add, delete, modify or change select package information and modify the business rules of the carrier, recipient and shipper that are associated with the delivery of the certain packages.

The following describes how the use of a UID provides inbound visibility to a user in accordance with an embodiment of the present invention. The process begins when a user is either assigned or creates a UID. In some instances a UID may be associated with one or more of a shipper's carrier (e.g., UPS) account number, though an account number is not required for use of a UID. Next, the user instructs his or her vendors, associated entities or even unrelated third parties to include the UID in the shipping information for packages bound for one or more locations. When a package is shipped having PLD information that contains a UID, the carrier captures the PLD data, including the UID, and the package visibility system identifies the package as being associated with the UID. As described herein, in one embodiment, packages bound for one or more given locations are identified via the UID. On a periodic basis and in a format determined by the user subscription information, the user associated with the UID receives information about the packages inbound to the designated one or more locations.

In the context of an outbound shipment, package visibility is obtained by having the shipper include the UID in those packages to be tracked. As the packages move through the carrier system, the packages are scanned and the PLD data is passed to the package visibility system. Package information is then formatted and sent to the subscriber in the time intervals and format specified by the subscription. In this way, a subscriber receives periodic updates that identify the location and estimated delivery times of the packages associated with the UID.

The package visibility system further includes an administration function that allows a user such as, for example, a corporate administrator to authorize and control access to the subscriber account. In one embodiment, the administration includes multiple levels of control and at least one of a UID administrator, a corporate administrator and a user account administrator. Some or all of these administrators may be able to authorize others to access, use or change a user account. And, in one embodiment, one or more of these administrators has control of security, quality and billing for a user account.

Computer and Computer Program Product

The embodiments of the present invention may be described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

As used herein, a computer may be a device having at least a means for entering information such as a keyboard, touchscreen, scanner, etc. and a means for displaying information such as a display, etc. The computer will also be capable of receiving and/or transmitting information. Such information may be transported over a network that may be wired, wireless, optical, or combinations thereof. In one embodiment, the computer may contain a processor and a memory, although in other embodiments the processor and/or memory may reside elsewhere. The computer may be at a fixed location such as a desktop, portable or it may be a hand-held device such as, for example, a DIAD as is used by UPS.

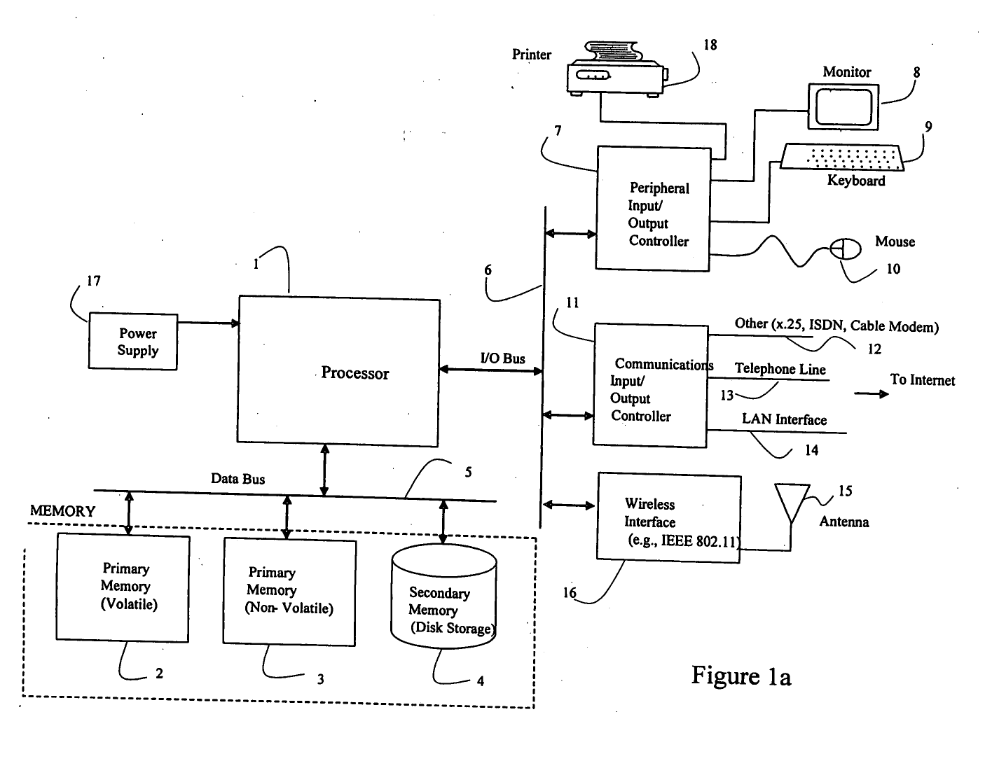

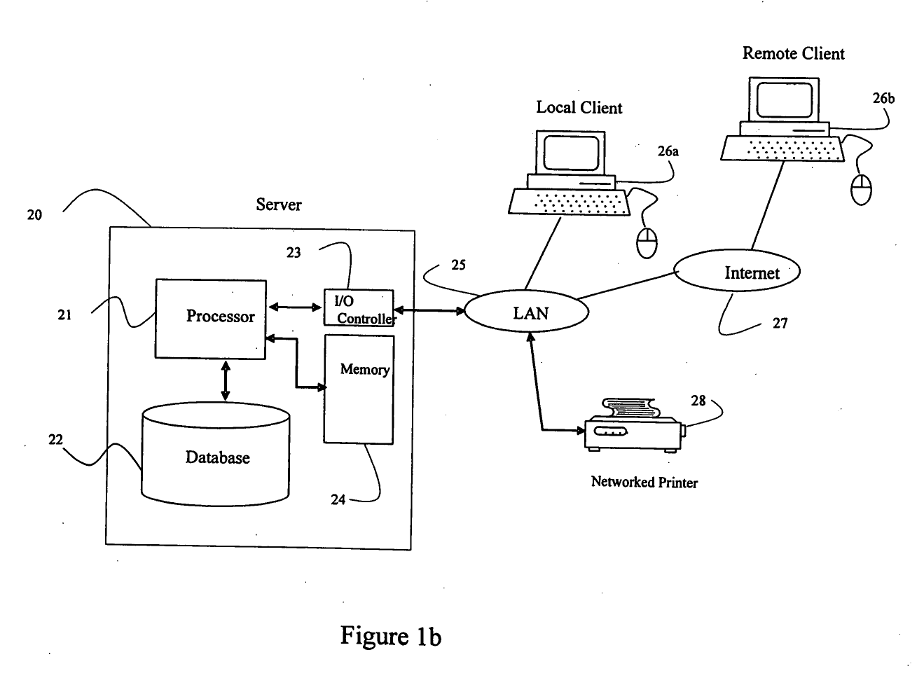

Turning to FIG. 1a, one embodiment of a computer is illustrated that can be used to practice aspects of the present invention. In FIG. 1a, a processor 1, such as a microprocessor, is used to execute software instructions for carrying out the defined steps. The processor receives power from a power supply 17 that also provide power to the other components as necessary. The processor 1 communicates using a data bus 5 that is typically 16 or 32 bits wide (e.g., in parallel). The data bus 5 is used to convey data and program instructions, typically, between the processor and memory. In the present embodiment, memory can be considered primary memory 2 that is RAM or other forms which retain the contents only during operation, or it may be non-volatile 3, such as ROM, EPROM, EEPROM, FLASH, or other types of memory that retain the memory contents at all times. The memory could also be secondary memory 4, such as disk storage, that stores large amount of data. In some embodiments, the disk storage may communicate with the processor using an I/O bus 6 instead or a dedicated bus (not shown). The secondary memory may be a floppy disk, hard disk, compact disk, DVD, or any other type of mass storage type known to those skilled in the computer arts.

The processor 1 also communicates with various peripherals or external devices using an I/O bus 6. In the present embodiment, a peripheral I/O controller 7 is used to provide standard interfaces, such as RS-232, RS422, DIN, USB, or other interfaces as appropriate to interface various input/output devices. Typical input/output devices include local printers 18, a monitor 8, a keyboard 9, and a mouse 10 or other typical pointing devices (e.g., rollerball, trackpad, joystick, etc.).

The processor 1 typically also communicates using a communications I/O controller 11 with external communication networks, and may use a variety of interfaces such as data communication oriented protocols 12 such as X.25, ISDN, DSL, cable modems, etc. The communications controller 11 may also incorporate a modem (not shown) for interfacing and communicating with a standard telephone line 13. Finally, the communications I/O controller may incorporate an Ethernet interface 14 for communicating over a LAN. Any of these interfaces may be used to access the Internet, intranets, LANs, or other data communication facilities.

Finally, the processor 1 may communicate with a wireless interface 16 that is operatively connected to an antenna 15 for communicating wirelessly with another devices, using for example, one of the IEEE 802.11 protocols, 802.15.4 protocol, or a standard 3G wireless telecommunications protocols, such as CDMA2000 1× EV-DO, GPRS, W-CDMA, or other protocol.

An alternative embodiment of a processing system than may be used is shown in FIG. 1b. In this embodiment, a distributed communication and processing architecture is shown involving a server 20 communicating with either a local client computer 26a or a remote client computer 26b. The server 20 typically comprises a processor 21 that communicates with a database 22, which can be viewed as a form of secondary memory, as well as primary memory 24. The processor also communicates with external devices using an I/O controller 23 that typically interfaces with a LAN 25. The LAN may provide local connectivity to a networked printer 28 and the local client computer 26a. These may be located in the same facility as the server, though not necessarily in the same room. Communication with remote devices typically is accomplished by routing data from the LAN 25 over a communications facility to the Internet 27. A remote client computer 26b may execute a web browser, so that the remote client 26b may interact with the server as required by transmitted data through the Internet 27, over the LAN 25, and to the server 20.

Those skilled in the art of data networking will realize that many other alternatives and architectures are possible and can be used to practice the principles of the present invention. The embodiments illustrated in FIG. 1a and 1b can be modified in different ways and be within the scope of the present invention as claimed.

Visibility Package System

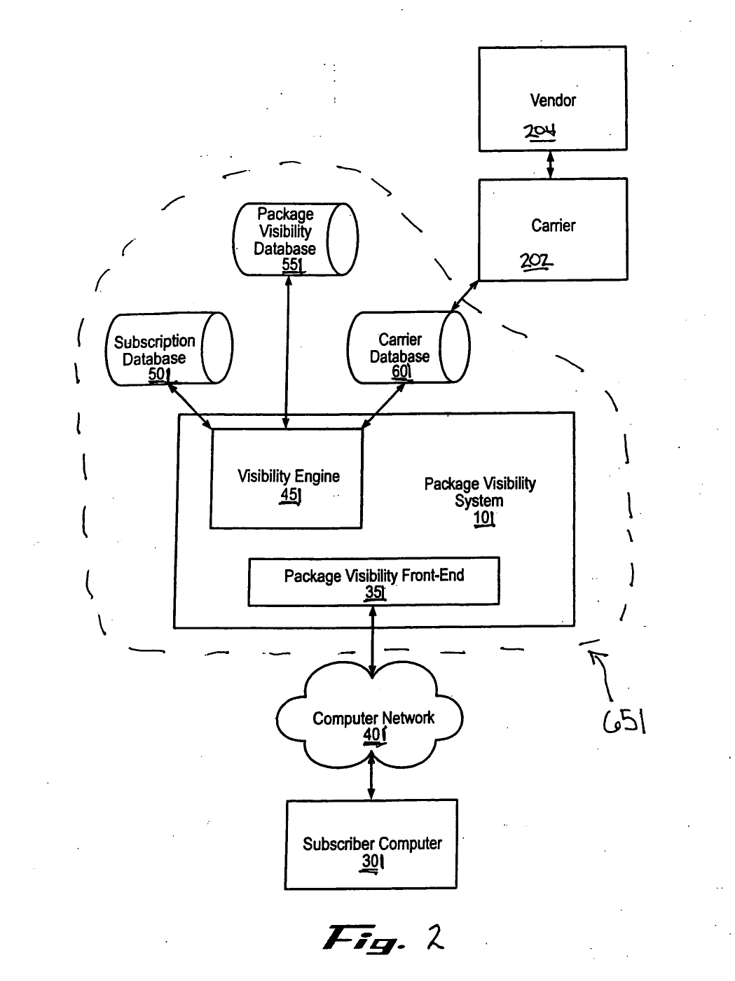

FIG. 2 illustrates a high-level block diagram of a visibility package system 101 in accordance with the present invention. An interface such as a subscriber computer 301 communicates with a package visibility front-end 351 via a network 401. In one embodiment, the subscriber computer 301 accesses the package visibility front-end 351 from a web site on the Internet and documents and/or other information are passed to and from a browser application that runs on the subscriber computer 301.

The visibility front-end 351 also communicates with a visibility engine 451, which in turn communicates with one or more subscription databases 501, a package visibility database 551 and one or more carrier databases 601. The visibility engine 451 may also communicate with various carrier 202, vendor 204 and subscriber applications and systems. In one embodiment, the visibility engine 451 resides on the same server as the databases (hereafter the package visibility server 651), but one of ordinary skill in the art will readily recognize that one or more of the databases can reside on separate servers or other computer systems. Although these components are described individually; one or more of the applications and/or databases may be divided into separate applications and/or files by function or by other means known in the art.

An exemplary package visibility system 101 that may be used in one or more embodiments of the present invention is described in U.S. patent application Ser. No. 10/265,079; “Inbound and Outbound Shipment Notification Methods and Systems,” filed Oct. 4, 2002, publication number US2003-0097287-A1, published on May 22, 2003, hereby fully incorporated herein and made a part hereof.

In one embodiment, the visibility front-end 351 is configured to capture user information from the subscribing computer 301 and is one means by which a tracking notification may be provided to subscribers. The visibility engine 451 is a back-end, or server-side application that processes subscriber information, package-tracking information and communicates with carrier 202, vendor 204 and subscriber systems. The subscription database 501 is a database wherein subscriber and account administration data is stored. For purposes of illustration, a single database is shown; however, one of ordinary skill will recognize that user and subscription information may be stored across multiple databases. The package visibility database 551 is a storage area where information about inbound and outbound packages is stored. In one embodiment, the data used to generate tracking notifications is taken from the package visibility database 551. The carrier database 601 illustrated in FIG. 2 represents a database in a carrier system that stores PLD information about packages in transit. One of ordinary skill in the art will readily recognize that multiple databases may also be used for this function.

Package Visibility Processes

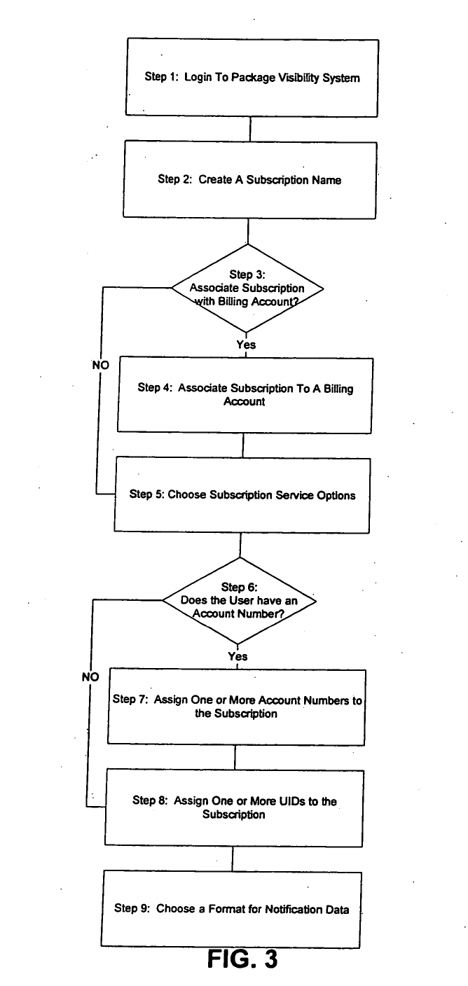

The following paragraphs describe the process of supplying a subscriber having one or more UIDs with visibility for packages that are inbound to or outbound from one or more locations and where such packages have been associated with the one or more UIDs. FIG. 3 is a flowchart that illustrates the steps in a process by which a user creates a subscription to receive visibility information about inbound and outbound packages. It is to be appreciated, however, that a user may not necessarily be required to have a subscription to view visibility information about inbound and outbound packages.

In Step 1 of FIG. 3, the subscriber accesses or logs into the visibility system. In one embodiment, the subscriber accesses a website and enters the login information from a webpage dedicated to that function. Alternatively, the subscriber may contact a customer service agent who enters the information into a package visibility system 101 as shown in FIG. 2 in response to instructions from the subscriber. If the subscriber has already registered with the visibility system, the login procedure may require that the subscriber enter a valid user ID and password. If the subscriber is a new user, another step may be required in which the subscriber is prompted for personal, billing and/or other identifying information. In other embodiments, the user may not be required to log into the visibility system, but may find it necessary to agree (e.g., a “click-through” agreement) to the use or limitations on the use of the provided visibility information.

In one embodiment, a carrier such as, for example, UPS operates the package visibility system 101, and subscribers may be required to have a valid carrier account before they are granted access to the package visibility system 101. In such case, user information from the pre-existing carrier account may be passed from a carrier user account database to the package visibility system 101 without requiring that the new subscriber re-enter the information. In any case, the necessary subscriber information is captured and stored in the subscription database 501. In other instances; however, a subscriber is not required to have a valid carrier account and may be granted visibility by simply knowing a particular UID.

In Step 2 of FIG. 3, the subscriber is prompted to create a subscription name. The subscription name should be unique to the subscriber because a single subscriber may have multiple subscriptions. But because the subscription is tied to a particular subscriber, the subscription name does not have to be unique as to all subscribers. As an example, a first subscriber that owns a business with two warehouses may create a first subscription “Inbound for Main Street warehouse,” and a second subscription named “Inbound for Maple Avenue warehouse.” As long as these subscription names are unique to the first subscriber, it will not matter if a second subscriber has used the same subscription name for another user account. Furthermore, subscriptions are not limited to inbound and are equally advantageous if established for inbound, outbound or inbound and outbound packages, as further described below.

In Step 3, it is determined whether the subscription is to be associated with a billing account. If so, then the process goes to Step 4. At Step 4, the subscriber is prompted to associate the subscription to a billing account. In one embodiment, this association is required because the package visibility system 101 as shown in FIG. 2 may, in some instances, be a fee-based system. However, the present invention is equally advantageous if provided as a free service, and in such case the step of associating the subscription to a billing account may be omitted.

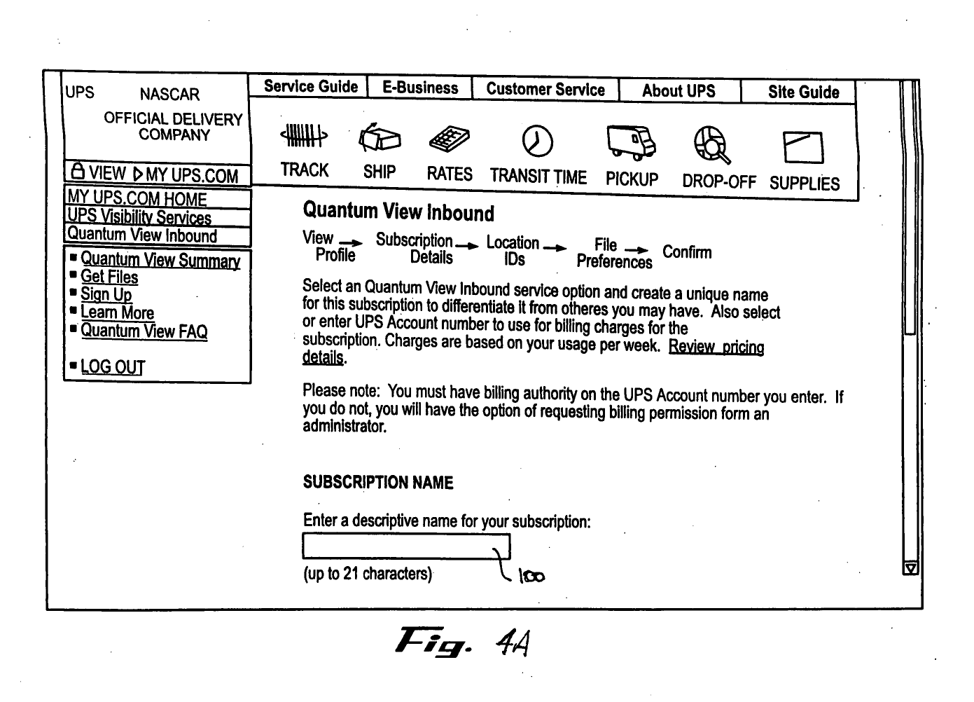

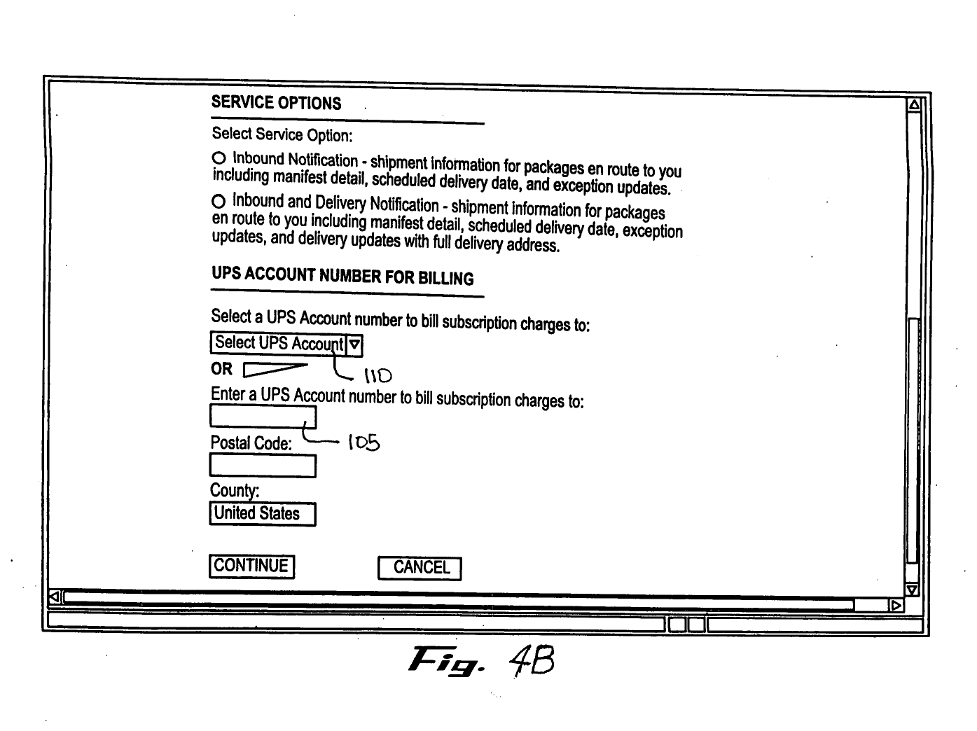

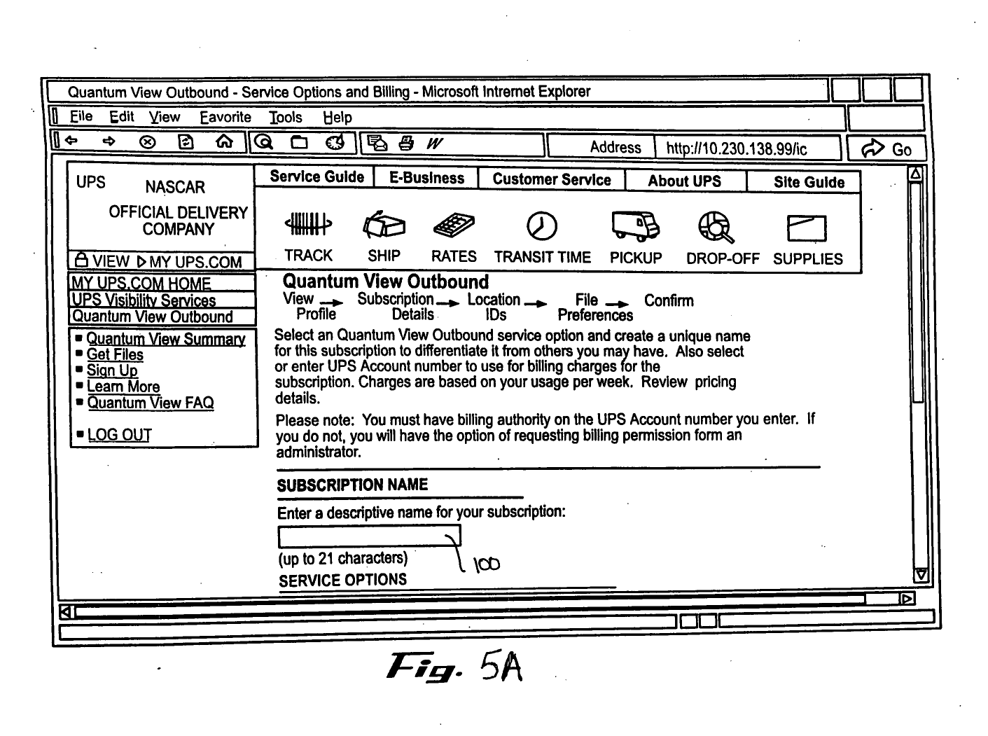

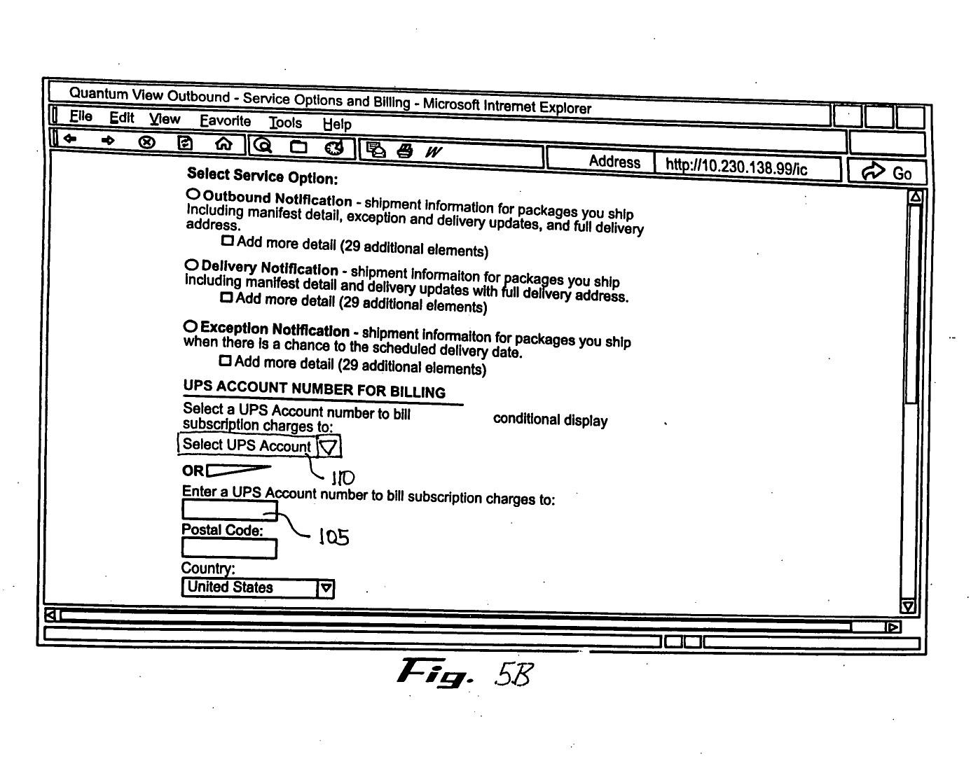

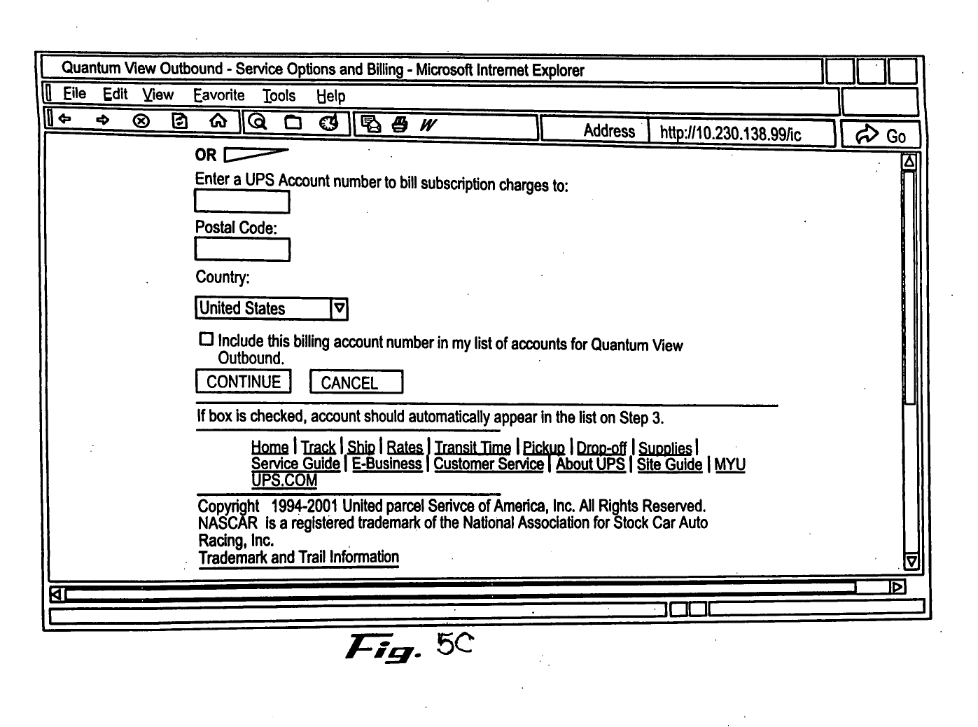

In one embodiment, separate subscriptions are required for inbound and outbound packages, though in other embodiments a single subscription will provide complete tracking information of all packages associated with the subscriber's UID, including inbound and outbound packages. FIGS. 4A and 4B are screen shots that illustrate a web page that might be used to capture subscription information from a subscriber for an inbound subscription, as such may be utilized, for example, in the package visibility front-end 351 as shown in FIG. 2. FIGS. 5A, 5B and 5C are screen shots that illustrate a web page that might be used to capture subscription information from a subscriber for an outbound subscription, as such may be utilized, for example, in the package visibility front-end 351 as shown in FIG. 2. In this illustration, the visibility tracking system 101 is marketed as a Quantum View™ system by United Parcel Service of America, Inc. of Atlanta, Ga., with the inbound portion of the system referenced as Quantum View Inbound™ and the outbound portion of the system referenced as Quantum View Outbound™. Via these web pages, a subscriber enters a subscription name of up to 21 characters in the subscription name field 100 as shown in FIG. 4A. The subscriber has the option of associating the subscription to a billing account by manually entering a billing account into a subscription billing account field 105 or by identifying a billing account from a list of billing accounts associated with the subscriber in a subscription billing account menu 110, as the account field 105 and menu 110 are shown in FIG. 3B.

The association of a billing account, if applicable, to a subscription may occur automatically or may require an additional authorization step. In one embodiment, when a user attempts to associate a billing account to a new subscription, the package visibility system 101 automatically generates an authorization request email to an email address associated with the billing account. In some cases, a billing account may have multiple email addresses and/or persons authorized to approve the addition of subscriptions to the account, and the user that is creating the new subscription may be prompted to choose from among the persons authorized to approve the request. One of ordinary skill in the art will recognize that the approval process can occur via email, facsimile, a web page or via other methods that are known in the art.

At Step 3, if it is determined that the subscription will not be associated with a billing account, then the process moves to Step 5.

In Step 5 of FIG. 3, the user has the option of choosing between the available subscription service options including, for example, inbound and outbound service options that may include: inbound notification and delivery notification; outbound notification and delivery notification; exception notification; etc. In one embodiment, the inbound notification service option provides the user with forecasted delivery dates for inbound packages, and exception updates should the delivery date change, the outbound notification service option provides complete information about outbound packages, including significant supply chain status updates through delivery with ship date, exception, and delivery detail. These services may also provide other information, including ship date, scheduled day of delivery (SDD), exception updates (including delivery exceptions) where rescheduled day of delivery (RDD) is calculated, shipped from and shipped to address information, a location identifier (LID) and UID. In one embodiment, the inbound and delivery notification service option includes all of the features of the inbound notification service option, plus delivery information about packages associated with a UID, including delivery date and time, signature, COD amount, reference numbers, and full delivery address. Finally, the exception notification service option provides information about packages shipped that do not make the scheduled date of delivery. In an embodiment, subscribers that elect to receive the exception notification option receive exception status updates and forecasts for rescheduled dates of delivery. In one embodiment, the shipping information provided to fulfill these services is provided via one or more carrier applications or via other methods that are known in the art. The relevant information is then captured by the visibility engine and passed to the subscriber.

In Step 6 of FIG. 3, it is determined whether the user has a carrier account number. If the user has a carrier account number, then at Step 7 the user is prompted to enter one or more carrier account numbers that will be used for outbound notifications. In one embodiment, carrier account numbers are account numbers used by carrier customers when shipping packages via the carrier system. When a package is shipped using a carrier account number that is associated with a subscription, information about the package is identified, assembled and updated by the visibility engine 451 shown in FIG. 2. The package information is then collected and using one or more of the notification methods described herein is presented or made available to a user having the account number and/or UID in accordance with requirements of the subscription.

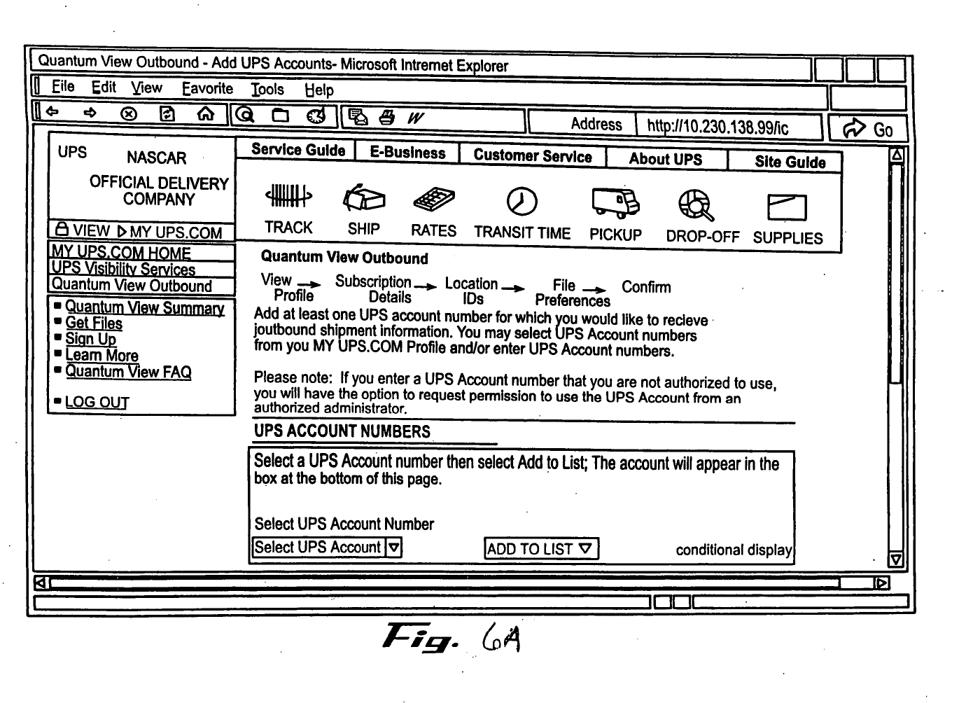

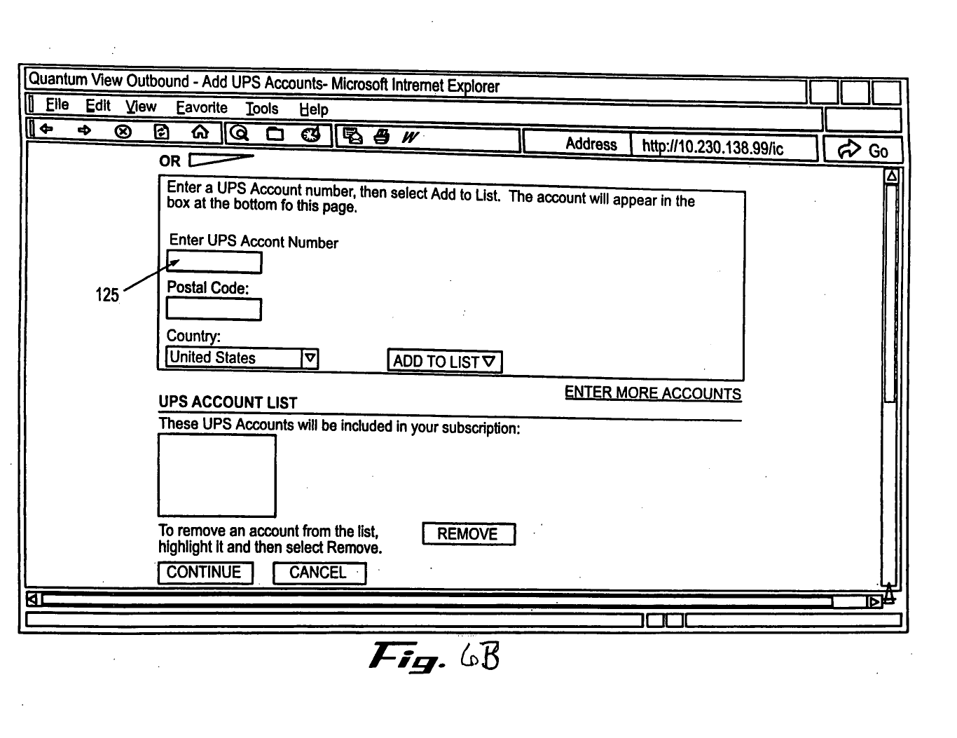

FIGS. 6A and 6B are screen shots that illustrate some of the ways in which carrier account numbers 125 are associated with an outbound subscription. One option available to users is to select from a pull down menu of carrier account numbers 125. In an embodiment, the pull down menu shows those carrier account numbers 125 associated with the user ID of the person who is creating the outbound subscription. Alternatively, the user may enter a carrier account number 125 in an account number field. If the user manually enters the carrier account number 125, a validation routine will confirm that the account numbered entered is a valid carrier account. In addition, if the user is not authorized to use the entered carrier account number, the system 101 generates an email request for authorization and sends the request to the email address associated with the carrier account that the user entered.

If, at Step 6, the user does not have a carrier account number, then the process goes to Step 8.

In Step 8 of FIG. 3, the user assigns one or more UID to the subscription. In one embodiment, UIDs are associated with a subscription in one of three ways: a new UID can be created for the subscription, a user can select from a list of existing UIDs, or the user can manually enter the UID. The process of creating a new UID is described in greater detail below;

therefore, the following paragraphs will describe the process of adding existing UIDs to a new subscription.

A user may associate one or more UIDs with a subscription via a web page on a website. In various embodiments, the user has the ability to link to another web page to create a new UID, select an existing UID from a UID pull-down menu, or to manually enter a UID. A list of UIDs associated with the subscription may be shown on the web page, and the subscriber has the option of adding and/or deleting UIDs from this list. In one embodiment, at least one administrator is associated with each UID and must approve the request before a UID is added to the subscription. The request to add the UID to a subscription and the approval and/or denial of the request by the UID administrator may occur via email, facsimile, web page or via other communications means that are well known in the art. In alternative embodiments, an authorization code or password may be required before a UID can be associated with a subscription. In still another embodiment, certain users may be pre-approved to associate certain UIDs with new subscriptions. Other means of maintaining administrative security and control are known in the art and can be used with the present invention, and additional detail about the administrative hierarchy is set forth below.

In Step 9 of FIG. 3, the user is prompted to choose a format for notifications associated with the subscription. In one embodiment, notification files are formatted as a comma-separated value, a flat file, or an XML file. But other file formats are known in the art and are equally advantageous with the present invention. In one embodiment of the present invention, the user is prompted for an email address in Step 8 and the appropriately formatted notification file is sent to the user as an email attachment. In another embodiment, notification files must be downloaded from a web page or other location and the email address is used to notify the user when the files are ready for pickup. Other methods of delivering notification data are known in the art and are described herein, and any of these methods can be selected and/or configured by the user at Step 8 in the subscription process.

Creating A New UID

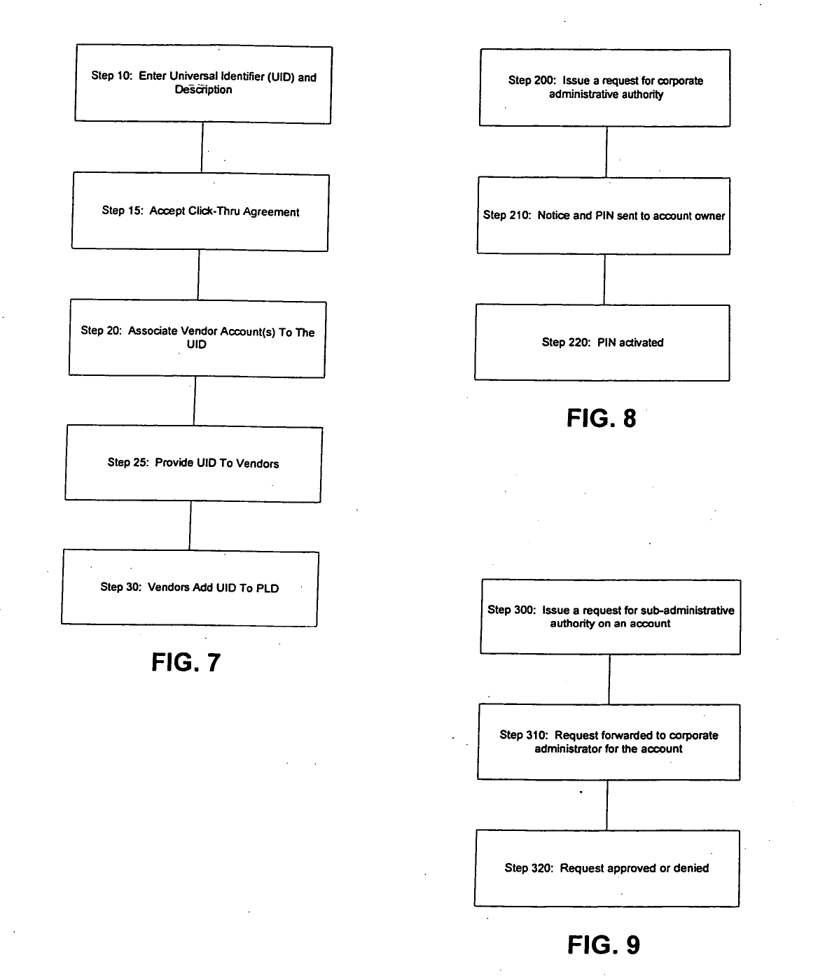

The following paragraphs describe the process of creating a new UID. FIG. 7 is a flowchart that illustrates the steps of a process by which a user creates a new UID in accordance with an embodiment of the present invention.

In Step 10, the user is prompted to enter a new UID using a combination of numbers, letters, symbols and/or characters. In one embodiment, the UID entered by the user should be an identifier unique to the user that will be used by the package visibility system 101 as shown in FIG. 3 to report shipment information. The user is also prompted to provide a description of the UID and shipping or receiving location addresses that may be associated with that UID.

In one embodiment, when a user creates a new UID, the user becomes a UID administrator for that UID, and receives the ability to approve or deny requests from other users to use that UID. Thus, when a user creates a new UID the user must first agree to a click-thru license agreement that requires that the user accept the terms and conditions associated with the role of UID administrator (as shown in Step 15). In an alternative embodiment, the creator of the UID does not automatically assume the responsibilities of UID administrator and a single UID administrator may be assigned to any UIDs created by a user or group of users. In addition, the license agreement associated with the UID administrator may be entered into offline or via other means known in the art.

Step 20 of the UID-creation process of FIG. 7 requires the user to associate one or more vendor account numbers to the UID. The user may associate as many or as few vendor account numbers to the UID as desired. In one embodiment, only those packages from vendors whose accounts are associated with a UID are reported in the notification reports. Allowing the UID administrator to limit those vendor accounts that are associated with a particular UID thus provides security and control to the notification process. For example, users do not receive notifications, and are not charged, when unauthorized vendors or other entities include a UID in packages. In an embodiment, only those authorized vendors that include the UID information in packages that are shipped from an authorized shipping location or that are bound for an authorized shipping location associated with the UID are included in the notification data.

In Step 25, the user has created a new UID and instructs vendors to include the UID in packages they send to the receiving locations associated with the UID, from shipping locations associated with the UID, to certain recipients, or shipping that occurs as a result of certain transactions. In one embodiment, a vendor email address is associated with the vendor account number and the vendor receives an email when the vendor account number is added to a UID. In an alternative embodiment, an additional step is included in the UID creation process that allows the user to customize an email to the vendors that instructs them regarding use of the new UID. One of ordinary skill in the art will readily recognize that other methods of communicating instructions to the vendor are well known in the art and will be equally advantageous with the present invention. Thus, in another embodiment, the communication of UID information from a subscriber to his or her vendors occurs outside the package visibility system.

In Step 30, the vendors add the new UID to the shipping information for packages bound to certain receiving locations associated with the UID, certain customers associated with the UID, certain shipping locations associated with the UID, or packages shipped subsequent to certain transactions. Depending on the vendor, the UID information may be manually entered or may be included in a vendor shipping system and automatically included in the PLD for each package bound for the receiving location. In an embodiment, the package visibility system 101 of FIG. 3 is operated by a carrier, and the carrier reserves a specific field for UID data. When a vendor ships a package to a receiving location associated with a UID, from a shipping location associated with a UID, to certain customers associated with a UID, or subsequent to certain transactions and includes the UID in the shipping information, carrier backend systems recognize the UID data and pass the package information to the visibility engine 451. The package visibility engine 451 identifies, assembles and updates package information for those packages in the carrier's system that have UID data in the shipping information. This information is then collected and reported to subscribers, using notification methods described herein, in accordance with the particular subscription requirements, or otherwise made available to users knowing a UID.

Establishing A Corporate Administrator

The following paragraphs describe the processes by which administrators are established using the package visibility system 101 as shown in FIG. 3. In one embodiment, administrators have control over user accounts and information to insure that only authorized users are able to subscribe and request billing charges for user accounts.

A first level of administration for a user account is the corporate administrator, which in one embodiment is authorized to create their own administrative requests, approve or deny requests made by other users, request additional services, receive email notifications of pending requests, block future administrative requests by individual users, and delegate authority to one or more sub-administrators. FIG. 8 is a flowchart that illustrates the steps required in a process to establish a corporate administrator in accordance with an embodiment of the present invention. In general, the process requires a user's request for corporate administrative authority to be confirmed by the account owner. As used herein, the term “account owner” refers to a user that has control over the account or is authorized to delegate administrative power for the account.

In Step 200 of FIG. 8, the user issues a request to receive corporate administrative authority for a user account. In one embodiment, the user is prompted to identify a user account for which the user is requesting authority and an email is sent to the account owner. The account owner may approve or deny the request. I approval is granted, the process proceeds to Step 210, and if the user's request is denied, the package visibility system 101 of FIG. 3 notifies the user of the denial via email, a web page document or via other means of notification that are known in the art.

In Step 210 of FIG. 8, the account owner receives a notification that a request for administrative authority has been made. The notification may be made via email, facsimile, mail, facsimile, webpage or via other communication means that are known in the art. In an embodiment, the notification includes a PIN that is generated by the package visibility system 101 of FIG. 3 in response to the request for corporate administrative authority.

In Step 220 of FIG. 8, the PIN is activated. If the account owner is also the user that has requested corporate administrative authority, the account owner can log onto the package visibility system 101 of FIG. 3 and activate the PIN. But if corporate administrator is not the account owner, the account owner is responsible for forwarding the PIN to the user that is receiving corporate administrative authority. In such case, one or both of the account owner and corporate administrator may be required to login to the visibility system 101 to activate the PIN. One of ordinary skill, however, will recognize that alternative processes for granting administrative authority can be used with the present invention. In an alternative embodiment, for example, an account owner receives a notification that a user has requested corporate administrative authority. To approve the request, the account owner logs into the package visibility system 101. Upon account owner approval, a PIN is generated and sent directly to the new corporate administrator. In some embodiments, both the account owner and the corporate administrator are required to activate the PIN, while in other embodiments, only one of the account owner and corporate administrator are needed to activate the PIN. In still another alternative embodiment, the corporate administrator will login to an administrative login screen of the package visibility system 101 to activate a PIN, and the initial login may be required to occur within a predetermined time to insure that the proper party received the PIN. Activation of a PIN can occur via a variety of methods that are well known in the art. In one embodiment, the activation of the PIN occurs upon activation of a hypertext link to a PIN uniform resource locator (URL).

Another level of administration available in one embodiment of the present invention is the sub-administrator. FIG. 9 is a flowchart that illustrates the steps required in a process to establish a sub-administrator in accordance with an embodiment of the present invention. In Step 300, a user issues a request to receive sub-administrator authority. In one embodiment, a user can request two types of sub-administrator authority, including the authorization to approve a subscription-billing request, and the authorization to access the shipping information for an account. Additional types of sub-administrator authority will be apparent to one of ordinary skill in the art.

In Step 310, the user request for sub-administrator authority is sent to the corporate administrator. In one embodiment, the corporate administrator of an account has the authority to approve or deny requests for sub-administrator authority. In alternative embodiments, the account owner must approve or deny any request for sub-administrator authority, or the account owner and corporate administrator must jointly approve of the sub-administrator request. In yet another alternative embodiment, the corporate administrator and/or the account owner can give a sub-administrator the power to approve or deny a request for sub-administrator authorization.

In Step 320, the user request for sub-administrator authority is approved or denied. In one embodiment, the approval and/or denial of a sub-administrator request is sent to the user via email. Alternatively, the user's profile in the package visibility system 10 is updated to reflect the approval or denial of the request and the user must check his or her profile to determine the status of the request. One of ordinary skill in the art will readily recognize that other methods of providing a status of the request are known in the art and may be used with the present invention. In one embodiment, the person or persons with authority to approve and deny administrative requests also have the ability to comment on the reason for approval and/or denial. This additional information can be made available to the user that initiated the request either via email or via the user profile. For example, if user request for administrative authority is denied, the user may be able to click on a link in his or her profile to obtain additional information as to the reason the request was denied.

Another level of administration available in an embodiment of the present invention is the UID administrator. As discussed above, one role of the UID administrator is to approve and/or deny the use of or access to UIDs in subscriptions. While a single UID administrator is assigned to each UID, multiple UIDs may be assigned to a single UID administrator. In one embodiment, the user that creates a UID automatically assumes the responsibilities of UID administrator. In an alternative embodiment, the account owner, the corporate administrator, or one or more sub-administrators assume the role of UID administrator. Thus, in this alternative embodiment, at least one administrator must approve the use of a UID with a subscription.

Use of UIDs

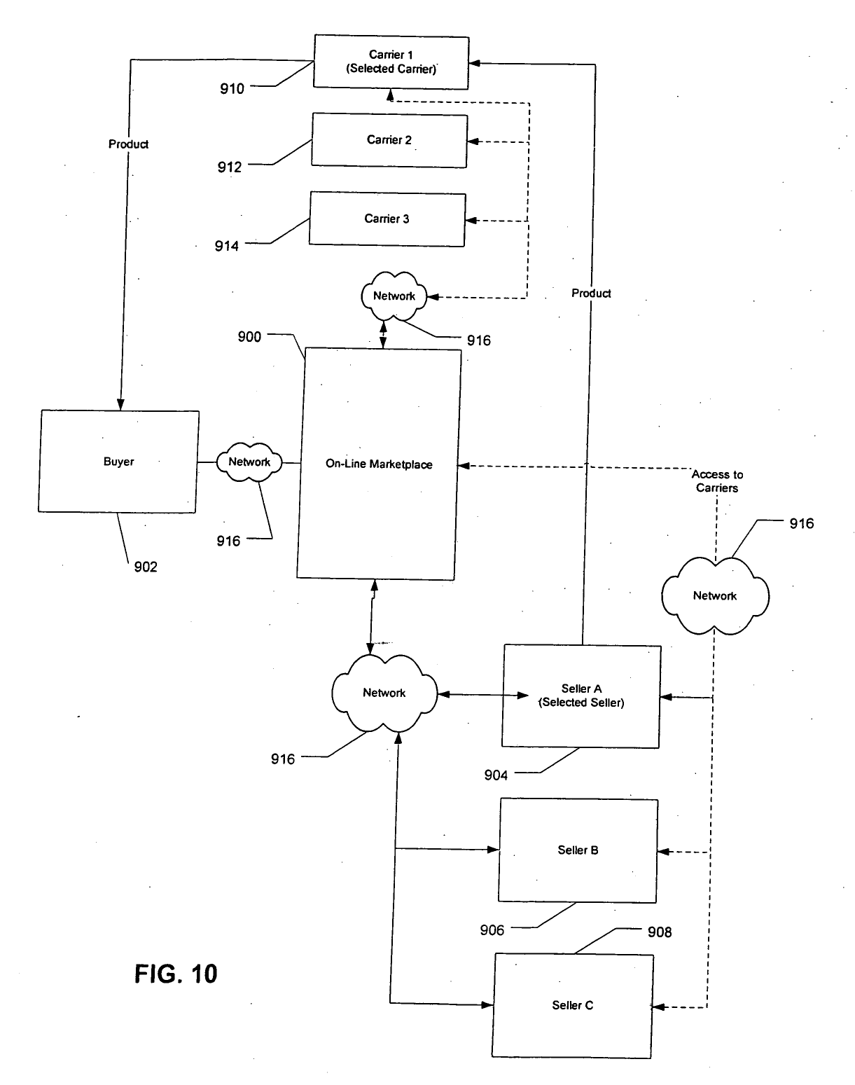

As illustrated in FIG. 10, the parties to an on-line buy/sell transaction conducted through a commercial on-line marketplace 900 include one or more buyers 902, one or more sellers 904, 906, 908 and the entity operating the on-line marketplace. For instance, the on-line marketplace 900 may allow sellers to offer their products on the on-line marketplace's website where potential buyers 902 may access the on-line marketplace 900 via a network 916 such as, for example, the Internet, and browse, bid on and/or buy the offered products. When a buyer 902 and seller (i.e., a selected seller) 904 reach an agreement for the purchase of a product offered on the on-line marketplace 900, the operator of the on-line marketplace may make shipping services available to the buyer 902 or seller 904 (i.e., the shipper) through one or more carriers 910, 912, 914 such as, for example, UPS, other package carriers, etc. The shipper may be able to click on a link in the on-line marketplace's website 900 to access their preferred carrier 910 or the on-line marketplace's website may reach out to the websites of various carriers to determine which of a set of carriers would provide the lowest rate for shipping the purchased product to the buyer 902 or the buyer's designee. The rate information will then be provided to the shipper on the on-line marketplace's website 900. The shipper may then select the desired carrier 910 and will be linked to the selected carrier's website where the shipper may prepare a shipping label that may be downloaded to the shipper's computer, or make other arrangements to ship the purchased product to the buyer 902 or to someone designated by the shipper. Generally, in the past, the on-line marketplace is no longer involved with the sales transaction once the seller 904 has been paid and the shipper has begun the process to ship the purchased product to the buyer 902.

However, the operator of the on-line marketplace 900 may want to be able to track packages that have shipped subsequent to buy/sale transactions conducted through the on-line marketplace 900. The operator of the on-line marketplace 900 may want to track these packages for a variety of reasons including to ensure that sellers 904, 906, 908 are shipping the purchased products to the buyers 902; to determine the number and types of packages that are being shipped by a certain carrier from transactions involving the on-line marketplace; to monitor the efficiency, rates, accuracy, and speed of various carriers 910, 912, 914; to receive discounted shipping rates for the customers of the on-line marketplace; to measure the volume of products shipped subsequent to buy/sale transactions occurring through the marketplace, etc.

In one embodiment of this invention, the on-line marketplace 900 is assigned at least one UID (also known as a universal identifier or universal ID). While UIDs are generally assigned by carriers 910, 912, 914, it is nevertheless contemplated under one or more embodiments of the present invention that a UID may be assigned by entities only affiliated with one or more carriers or even by independent third-party entities. In one embodiment, shipping transactions that occur as a result of transactions involving the on-line marketplace 900 include the UID of the on-line marketplace 900 in package information. Including the on-line marketplace's UID in package data may be accomplished by the carrier 910 chosen to ship the products having knowledge that the inception of the shipping transaction was through the on-line marketplace's website 900. This knowledge may be provided to the carrier 910 through the use of “cookies” or other certificates (digital or otherwise) assigned to the shipper and the shipper's computer when the shipper accesses the on-line marketplace's website 900, as such technology is known in the art; by the carrier correlating the IP address of the website that handed off the shipping transaction to the carrier with a UID; or by the shipper identifying the shipping transaction occurring as a result of a buy/sell transaction brought about by the on-line marketplace 900. The UID of the on-line marketplace 900 is either provided to the carrier, or sufficient information (such as one or more of the name, carrier account number, IP address, telephone number, address, etc.) of the on-line marketplace 900 is provided to the carrier 910 so that the carrier 910 may determine the LID of the on-line marketplace. The UID of the on-line marketplace 900 will be included in the package level detail (PLD) of each package of each shipment that is determined to have its inception in the on-line marketplace 900. This PLD information will be stored in one or more data repositories of the carrier 910. The carrier 910 will be able to provide shipping information regarding packages that have a certain unique UID to the entity or person that has been assigned the UID or to other authorized parties. Such information may include, for example, tracking and delivery information including proof of delivery of the packages as well as billing information.

In one embodiment, the shipper that is facilitated in access to a carrier's website through the on-line marketplace's website 900 will be provided an option to have one or more mailing labels downloaded to the shipper's computer, emailed to the shipper, made available for printing locally by the shipper from the carrier's website or server, mailed or delivered to the shipper, or otherwise made available to the shipper. The package level information for each mailing label will include the UID of the on-line marketplace 900. The UID may, in some instances, be shown on the actual mailing label in human-readable form, machine-readable form (e.g., barcode, RFID, etc.), or both.

An administrator such as a corporate administrator, sub-administrator, or UID administrator, as each are previously described, will control the access to package information of an entity possessing a UID (a “user”). For instance, in one embodiment an entity possessing a UID will log on to a carrier's package visibility system. Generally, this will be accomplished via the Internet and through the carrier's website by use of a password and/or username, though other means are contemplated in this invention, including dial-up, direct connection, etc. After gaining access to the carrier's package visibility system, the user will enter one or more UIDs unique to that user. A user's access to information will be controlled by rights assigned to the UID by one or more of the previously described administrators. The user will then enter the one or more UIDs into, for example, a screen associated with the carrier's information system. Information about packages that have the entered one or more UIDs as part of their package level information will then be displayed or provided to the user. The level, amount, sensitivity, and the user's ability to change modify or delete information is controlled by the one or more administrators. For example, the user may only be allowed to view tracking information, or the user may only be allowed to view only delivery information; in other instances, however, the user may have rights to modify certain package level information such as, for example, the intended recipient and/or the delivery location.

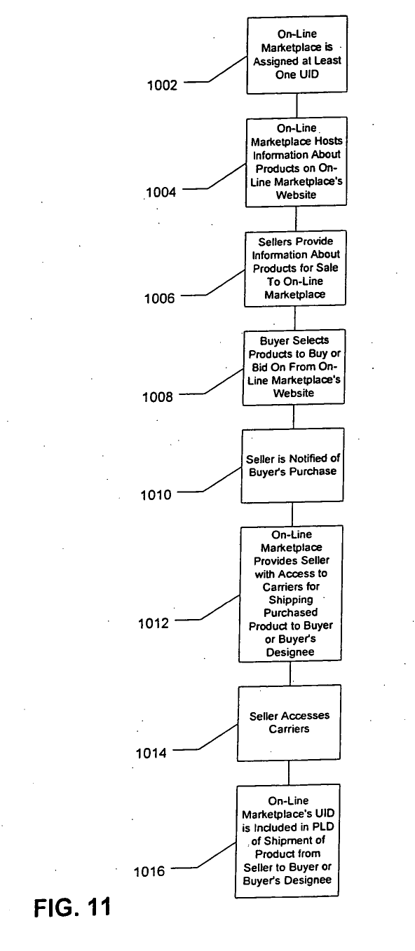

FIG. 11 is a flowchart describing the use of a UID in the context of an on-line marketplace. In Step 1002, the on-line marketplace is assigned at least one UID. At Steps 1004 and 1006, one or more sellers place information about products they have for sale on the on-line marketplace's website, and the information is hosted by the website, as such technology is known in the art. At Step 1008, a buyer accesses the on-line marketplace's website and selects one or more products to purchase or bids on selected products. If the buyer places a winning bid, the buyer then purchases the selected product(s). At Step 1010, the seller is notified of the buyer's purchase and arrangements are made for payment. At Step 1012, in this embodiment the seller is provided with an option to access one or more carriers from the on-line marketplace's website for shipping the purchased product from the seller to the buyer, or the buyer's designee. The seller then selects one of the provided carriers and is linked with the carrier's website at Step 1014. At Step 1016, the UID of the on-line marketplace is included in the PLD information associated with the packages containing the purchased product and maintained by the carrier. This can be accomplished by the means previously described.

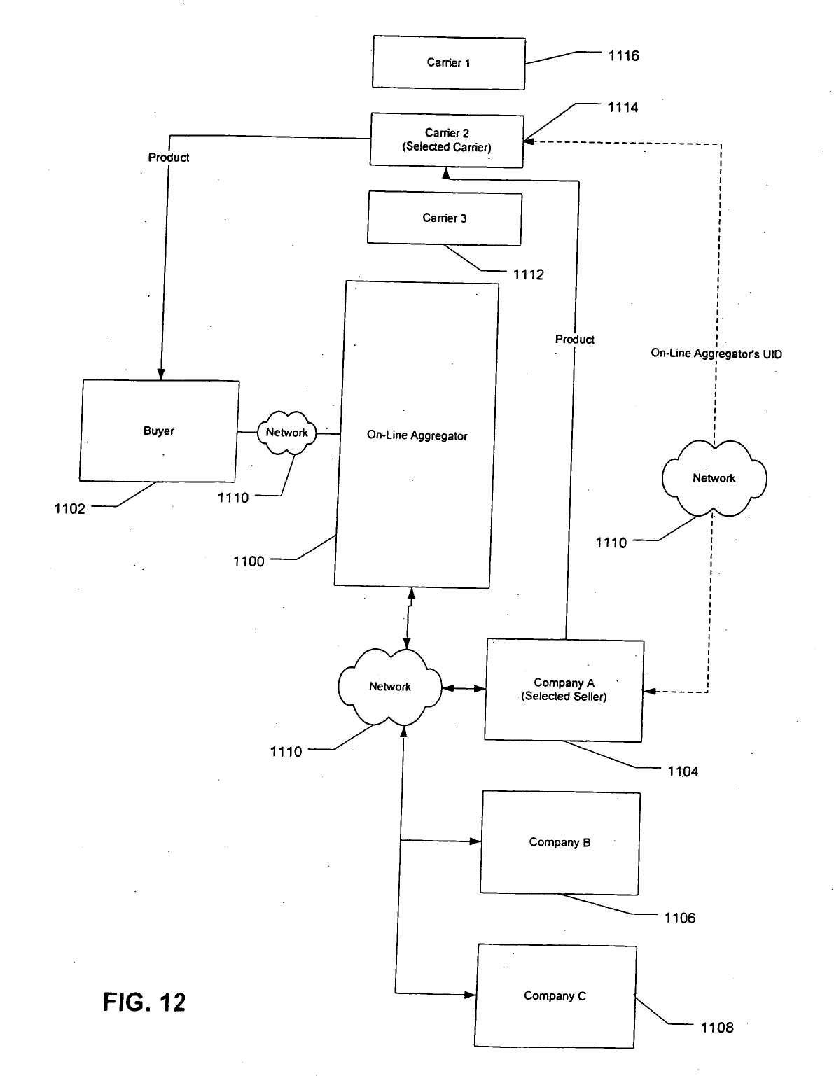

In another embodiment of the described invention, as illustrated in FIG. 12, on-line aggregators 1100 that match one or more buyers 1102 with one or more on-line retailers 1104, 1106, 1108 of desired products. One such example of an on-line aggregator 1100 is CNET.COM TM (www.cnet.com). In an embodiment of the invention, an on-line aggregator 1100 is assigned one or more UIDs and is able to track packages that are shipped as a result of searches for particular products that began at the aggregator's website. On-line aggregators 1100 serve as a search engine for on-line shoppers interested in certain types or classes of products. Very popular items for aggregators 1100 include consumer electronics such as computers, video players, camcorders, televisions, stereo equipment, etc. A shopper accesses an on-line aggregator's 1100 website via a network 1100 such as, for example, the Internet, and enters a search term into the aggregator's 1100 website or clicks on one or more predefined searches and is generally provided with a list of links to on-line retailers, wholesalers or other sellers such as Company A 1104, Company B 1106, and Company C 1108 and the sellers' price for the desired product. The shopper may then choose the seller (Company A 1104) of their choice, whether it is the least-cost retailer or one that the shopper chooses for other reasons.

Once the shopper has made their purchase selection(s) from the seller's website, shipping arrangements will be made to ship the purchased product(s) from the seller to the buyer 1102 or the buyer's designee via a selected carrier 1114. The UID of the on-line aggregator 1100 will be included in the package level detail of each package that comprises a shipment from the on-line retailer 1104 to the buyer 1102 or the buyer's designee. The UID of the aggregator 1100 “follows” the shopper to the seller's website 1104 in the same manner as previously described for transactions involving an on-line marketplace 900. Essentially, the on-line seller 1104 is provided with the knowledge that the inception of the shipping transaction was through the on-line aggregator's 1100 website. This knowledge may be provided to the on-line seller 1104 through the use of “cookies” or other certificates (digital or otherwise) assigned to the shopper by the on-line aggregator 1100, as such technology is known in the art; by the seller 1104 correlating the IP address of the website that handed off the purchase and shipping transaction with a UID; or by the shopper identifying the shipping transaction as one occurring as a result of a buy/sell transaction brought about by the on-line aggregator 1100. In one embodiment, the on-line aggregator 1100 may perform the initial processing of a shopper's order and then hand the transaction off to a seller 1104 with shipping instructions that include the UID of the on-line aggregator 1100. The on-line seller 1104 may include the UID in the human-readable or machine-readable information on a mailing label so that such information may be recorded by the carrier when obtaining the package for delivery. In other embodiments, the on-line seller 1104 may use a commercially-available shipping/mailing system that may have a database that interfaces with one or more carriers 1112, 1114, 1116 or that has information that may be transferred to one or more carriers 1112, 1114, 1116, where such information may include package information about shipments from the on-line seller 1104 including the UID of the on-line aggregator 1100. One such shipping/mailing system is described in U.S. patent application Ser. No. 09/315,680; filed May 20, 1999 and assigned to United Parcel Service of America, Inc.,; U.S. Pat. No. 5,631,827 (application Ser. No. 471368), issued on May 20, 1977 to Nicholls et al.; and U.S. Pat. No. 5,485,369 (application Ser. No. 128358), issued on Jan. 16, 1996 to Nicholls et al., each of which are fully incorporated herein in their respective entireties and made a part hereof.

As described above, once a package is associated with at least one UID, and such UID information is maintained in the package level detail repositories of the selected carrier 1114, the UID assignee (e.g., the on-line aggregator) 1100 or other authorized users may access the data as permitted by the one or more administrators.

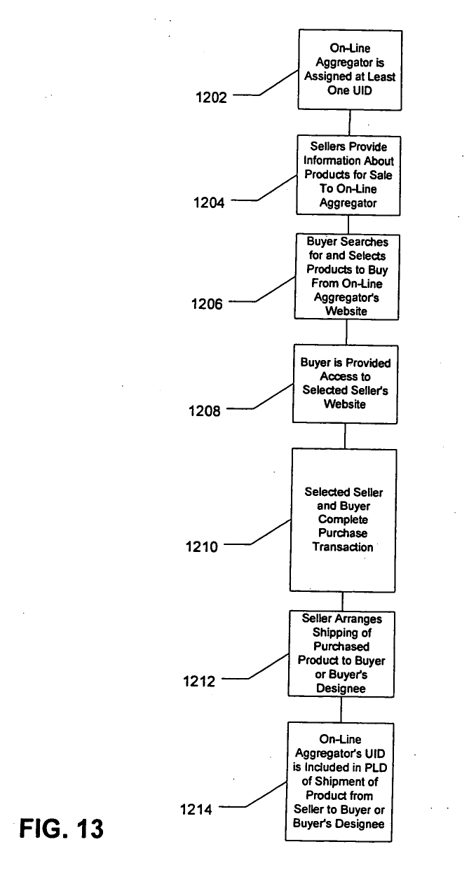

The flowchart of FIG. 13 illustrates one method of associating packages shipped subsequent to a buy/sell transaction beginning with an on-line aggregator with at least one UID of the on-line aggregator. At Step 1202, the on-line aggregator is assigned at least one UID. At Step 1204, on-line retailers either allow the on-line aggregator to access their websites to obtain information (e.g., cost, description, etc.) about their products or provide such information to the on-line aggregators. At Step 1206, a buyer accesses the on-line aggregator's website, searches for, and selects one or more products to buy. At Step 1208, the buyer is linked to the selected on-line seller's website through the on-line aggregator's website. At Step 1210, the selected on-line seller and the buyer complete the purchase transaction(s). At Step 1212, the on-line seller arranges to have the purchased item(s) shipped to the buyer or the buyer's designee by a selected carrier. At Step 1214, at least one UID of the on-line aggregator is included in the shipping information provided to the selected carrier such that the on-line aggregator may access the carrier's package visibility system to obtain information about shipment(s) having at least one of the aggregator's UIDs in the packages PLD information.

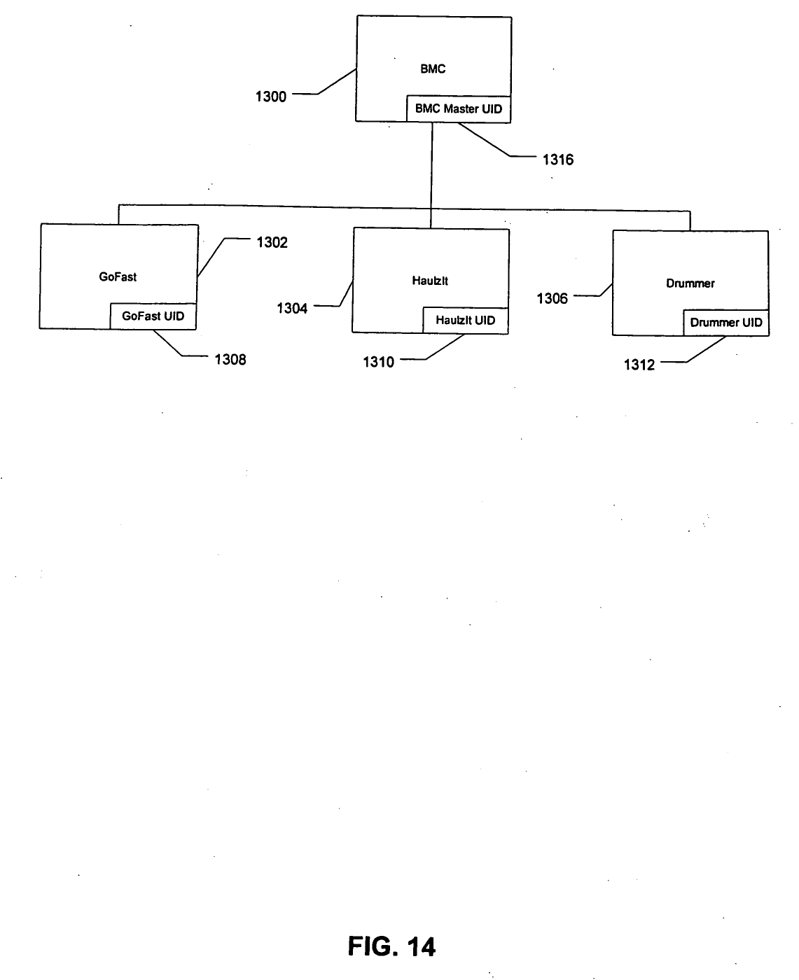

In other embodiments, a UID may have a hierarchical or parent-child relationship with one or more other UIDs. Consider an exemplary large manufacturer that wants information about carrier shipments to and from all of its facilities, but may also want to obtain information about shipments related to specific product lines and/or facilities. For example, consider a hypothetical huge automobile manufacturer as illustrated in FIG. 14 and having several lines of automobiles and plants throughout the world. The auto manufacturer, Big Motor Company (BMC) 1300, produces one auto called the GoFast 1302, another called the Haulzlt 1304, and yet another called the Drummer 1306. A UID can be assigned to carrier shipments to BMC for each product line, GoFast, Haulzlt and Drummer. In other words, a UID 1308 unique to BMC will be assigned to shipments related to the GoFast, another UID 1310 unique to BMC will be assigned to shipments related to Haulzlt, and yet another UID 1312 unique to BMC will be assigned to shipments related to the Drummer product line. Furthermore, a “master” UID 1316 is assigned to BMC 1300 such that any shipment to or from BMC 1300 (regardless of product line or even whether associated with any product line) will be correlated with the BMC UID 1316. A hierarchical relationship exists between the product line UIDs 1308, 1310, 1312 and the master UID 1316 of BMC. In other words, the product line UIDs 1308, 1310, 1312 assigned to shipments related to GoFast 1302, HaulzIt 1304 and Drummer 1306 are associated with the master UID 1316 assigned to BMC 1300. Shipments that are related to a product line may contain only the product line's UID in the shipments package level detail; however, the UIDs of each of BMC's products lines may be hierarchically linked to BMC's master UID through the use of a relational database, table, software coding, or other means known in the art. This will allow reporting of information relating to all of BMC's shipments, regardless of products line, as well as reporting of shipment information relating to specific product lines. For instance, if BMC 1300 wants a report of shipments related only to the GoFast 1302 product line, BMC 1300 may select such a report by entering or selecting only the UID 1308 of GoFast 1302 and only packages having the specified UID in their package level detail will be included in the report. Furthermore, it is to be noted that a UID assigned to one or more packages may be used to track the one or more packages as they pass from one carrier to another (carrier to carrier) and from one transportation mode to another (e.g., from automobile to train to rail to ship, etc.) The UID may be carried in the package data of the carrier to whom the one or packages are passed, or the UID may be associated or linked with the tracking data of the carrier receiving the one or more packages by, for example, tracking numbers assigned to each of the one or more packages that are correlated with the UID in a table such that the package tracking system of the receiving carrier can be accessed to determine that status of the one or more packages.

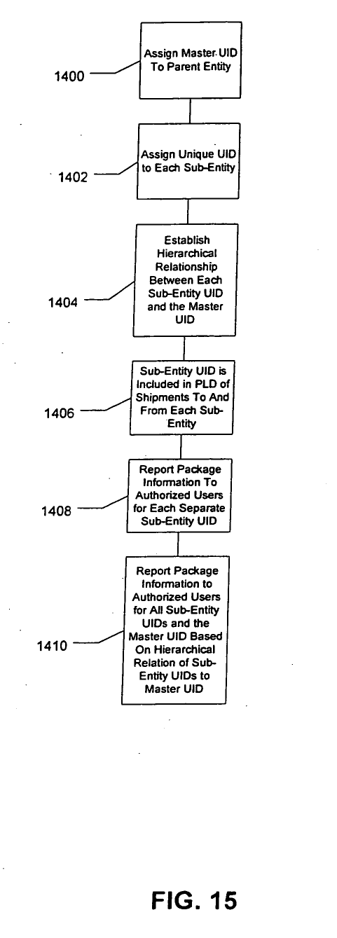

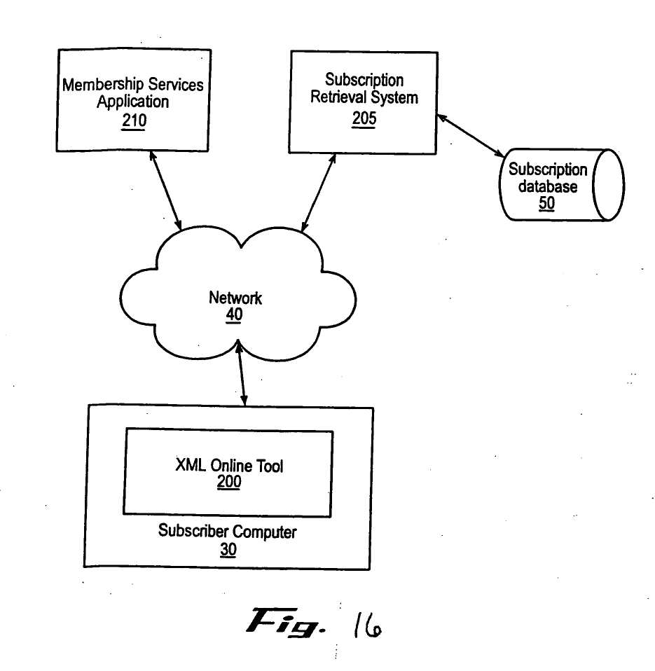

FIG. 15 is a flowchart describing one method of associating a master UID to sub-entity UIDs. At Step 1400, a “master” UID is assigned to a parent entity. At Step 1402, UID is assigned to each sub-entity. Each sub-entity UID is unique to the parent entity. At Step 1404, a hierarchical or parent-child relationship is established between each sub-entity UID and the master UID. At Step 1406, the UID of a sub-entity is included in carrier shipments to and/or from the sub-entity, for example in the PLD data associated with each package. At Step 1408, the carrier's package visibility system is capable of reporting package information to authorized users on packages having a sub-entity UID included in their PLD. At Step 1410, the carrier's package visibility system is capable of reporting package information to authorized users on packages having any sub-entity UID as well as any packages having the master UID included in their PLD, based on the hierarchical relationship of the sub-entity UIDs to the master UID.

One method of including a UID in package level detail include the embodiments described above where the UID of an on-line marketplace's or an on-line aggregator's website “follows” the shopper or user to a carrier's or a seller's website. Also, as described above, a shipper's carrier account number can be correlated with one or more UIDs such that the one or more UIDs are included in the PLD information for packages shipped by the shippers. Other methods of including a UID in package level detail include having the ship to address and/or the ship from address of a package processed by an address matching system so that one or more UIDs, such as the UID of the entity receiving the package, the UID of the entity shipping the package, or the UID of some third-party entity that is associated in some manner with the shipping transaction, is added into the package level detail information if the ship to and/or ship to addresses are found to be associated via the address matching system with one or more UIDs. Such address matching systems are known in the art. One such system is disclosed in U.S. patent application Ser. No. 10/690,322; filed Oct. 21, 2003, and assigned to United Parcel Service of America, Inc., which is incorporated herein in its entirety and made a part hereof. Yet another means of including UID information in package level detail is through the use of commercially-available shipping software and systems that interact with one or more carriers' systems over a network. Some of these systems interact with only one carrier, whereas others allow the shipper to select from among a set of carriers (often called “carrier management systems.”) As previously described, one such system is described in U.S. patent application Ser. No. 09/315,680; filed May 20, 1999 and assigned to United Parcel Service of America, Inc., previously incorporated herein. Such shipping/mailing systems are capable of including the UID of the shipper and the intended recipient, as well as the UID of one or more third parties to the shipping transaction in the package level detail. This information can then be transferred to the data repositories of the carrier selected to transport the packages, as such technology is known in the art, and can be used to providing information regarding the packages to the assignee's of the UIDs included in the package level detail.

Notification Systems

In an embodiment, the present invention encompasses a variety of notification methods and systems. The package visibility system 101 as shown in the embodiment of FIG. 2 provides a first user, on a subscription basis, the ability to receive a subset of tracking information specific to packages that are inbound to or outbound from the user or one or more other users. The information that is available to the first user includes, but is not limited to delivery information, exception information, manifest and origin information, billing information, etc., as discussed in greater detail below.

In one embodiment, a user has the ability to subscribe to a visibility system 101 of the present invention via a website on the Internet. The process may be a fee-based subscription and the user has the option of subscribing to a subset of the offered services. In one embodiment, a user has the option of subscribing to three outbound services; exception notification, outbound notification, and delivery notification, and two inbound services; inbound notification and inbound and delivery notification. If the user subscribes to more than one of the subscription-based services, the user may be prompted or may be assigned a subscription name that corresponds to the service. In addition, as part of the subscription process, the user is prompted to specify the file format in which the information will be sent to the user. In one embodiment, a user must specify a single file format that will be used for all of the subscription services. But in alternative embodiments, users may select different file formats for different services. For purposes of illustration, the following paragraphs describe a process wherein a user requests an XML file format. XML formats are well known in the art, but one of ordinary skill will recognize that multiple other file formats are known that can be used with the present invention.

Outbound visibility services provide a method for subscribing users to obtain a data message on a request basis that contains package information for one or more carrier account numbers. In one embodiment, outbound visibility services consist of three services that subscribers can specify during the subscription process: outbound notification, exception notification and delivery notification. In general, outbound notification provides information about packages that are outbound from the subscribing user, including but not limited to supply chain status updates through delivery with ship date, exception and delivery detail. Delivery notification provides delivery details and manifest information, including ship date, date and time of delivery, reference number, full delivery address and COD amount collected. Exception notification provides information about packages that will not make the scheduled date of delivery, and in one embodiment includes a re-scheduled date of delivery.

Inbound visibility services provide a method for subscribers to obtain a data message on a request basis that contains shipment information for one or more UPS account numbers. In one embodiment, inbound visibility services comprise two services that a subscribing user may specify during a subscription process: inbound notification and inbound and delivery notification. Inbound notification provides forecasted delivery dates for inbound packages, as well as any exception updates that could potentially change the delivery dates. In one embodiment, the service also provides other information, including ship date, scheduled date of delivery, exception updates where rescheduled day of delivery is calculated, shipped from and shipped to address information and UID. Inbound and delivery notification includes all of these features and additionally includes delivery information about packages associated with UIDs that have been shipped and/or received, including delivery date and time, signature, COD amount, reference numbers, and full delivery address.

The Online File Download Tool

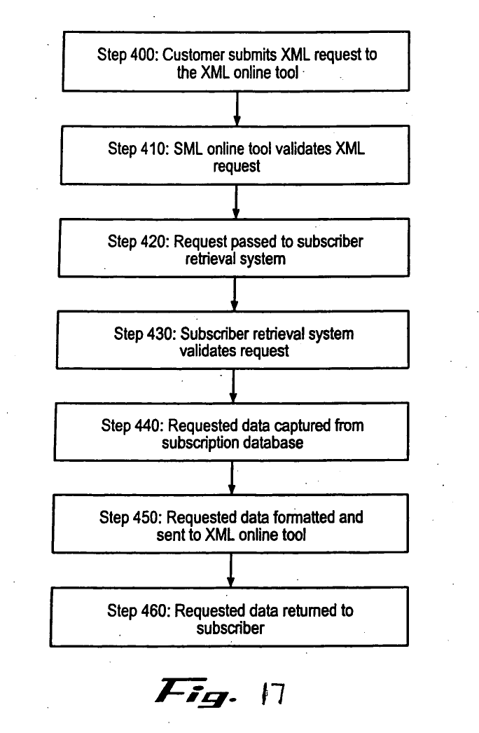

FIG. 16 is a system diagram that shows the communication between an online file download tool (hereafter the XML online tool 200) and the various backend applications of the visibility system 101 referenced in FIG. 2 in accordance with an embodiment of the present invention. The XML online tool 200 serves as an application programming interface between a customer and the backend systems. XML is used herein because it is a common file format that is known in the art, but one of ordinary skill will readily recognize that other file formats can be used with the present invention.

In this illustration, a subscription retrieval system 205 is a backend application in the package visibility system 10 that communicates via a network 40 with the XML online tool 200 to process and manage the listing and retrieval of subscription files from a subscription database 50. Another backend system referred to herein as a membership services application 210 communicates with the XML online tool 200 to provide security and access rights and privileges to the customer.

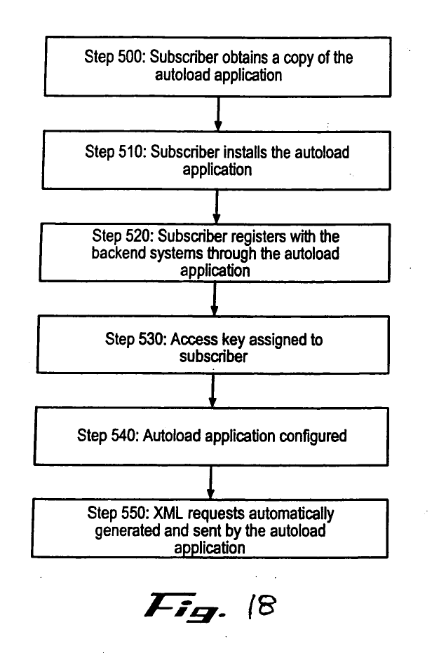

FIG. 17 is a process flow that illustrates how a customer XML request is processed. In Step 400, the customer submits an XML request to the XML online tool 200. In Step 410, the XML online tool 200 validates the XML request. The validation process validates the customer's rights to access the XML online tool 200 and its associated version. In one embodiment, the customer must submit a valid user ID, password and access license number, and this information is passed to the membership services application 210 via the network 40. If the customer is appropriately authorized, the process continues to Step 420 where the XML request is processed. But if validation process fails because the customer has not submitted a valid user ID or password, or because the customer is not authorized to perform the requested operation, the XML online tool 200 returns an error code that identifies the problem.

In Step 420, the XML online tool 200 passes the XML request to the subscriber retrieval system 205 via the network 40, and in Step 430 the subscriber retrieval system 205 validates the request. In one embodiment, the subscriber retrieval system 205 validates the format of the data that comprises the XML request. To illustrate, if a subscription name or filename is passed in the XML request, the subscriber retrieval system 205 confirms that the subscription and/or filename received have the proper data length and character type.

The XML request submitted by a customer may include different types of information. For example, a customer may request all of the unread data (i.e. data that has not previously been provided to the customer) for a particular subscriber identifier. Alternatively, a customer may submit a subscriber identifier and at least one subscription, in which case the customer will receive the unread data associated with the identified subscription(s). As another example, the XML request may include a subscriber identifier, subscription name, and at least one filename. In such case, the subscriber retrieval system 205 captures all the data (read and unread) for the identified subscription and formats and returns the data to the identified filename. In still another example, the customer may request all of the data (read and unread) for a subscriber identifier within a specified date and time range. And in yet another example, the customer may request all data for a subscriber identifier for a particular subscription name within a specified data and time range. These are just a few of the types of data retrieval requests that a customer may submit via the XML tool 200. One of ordinary skill will readily recognize that other types of XML requests may be submitted using the described system and processes.

In Step 440 the subscriber retrieval system 205 communicates with the subscription database 50 and captures the data identified in the customer's XML request. In Step 450, the subscriber retrieval system 205 formats the data and sends it to the XML online tool 200 via the network 40. Finally, in Step 460 the XML online tool 200 returns an appropriately formatted response to the customer.

Autoload

Another aspect of the present invention is an automated access and file download application 250 (hereafter an autoload application 250) and method that allows a customer to schedule automatic downloads of their subscriber data. An autoload application 250 is installed on a customer computer system, which communicates with the XML online tool 200 and generates XML requests according to user-defined parameters. According to a customer-defined schedule, the autoload application 250 automatically generates the customer's XML request and retrieves and stores the subscriber data in the location and format specified by the customer's inbound and/or outbound subscription.

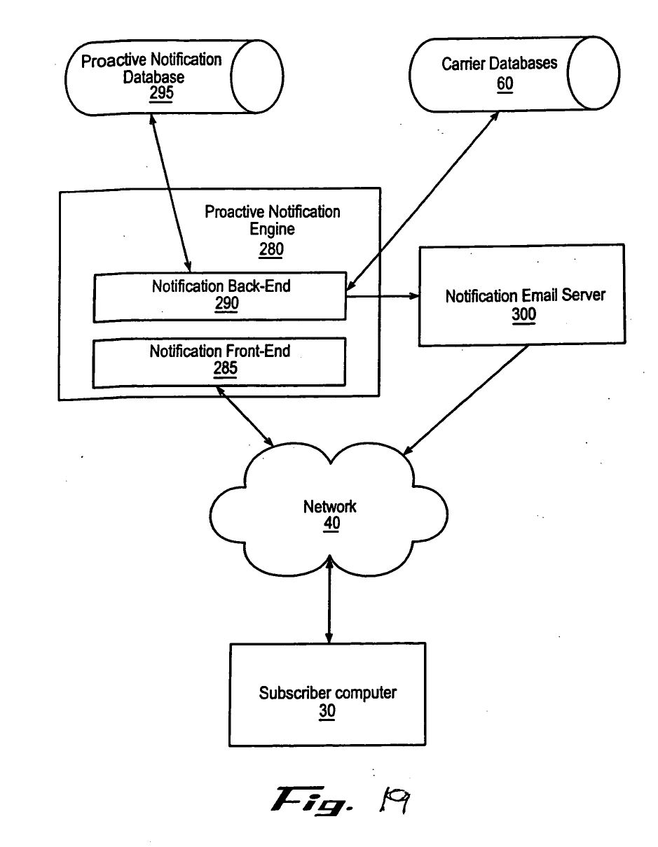

FIG. 18 is a process flow diagram that illustrates the steps to install and configure an autoload application 250. In Step 500, a customer obtains a copy of the autoload application 250. In one embodiment, the customer downloads the autoload application 250 from a provider site. Alternatively, the autoload application 250 may be provided to the customer on a CD-ROM or other electronic media, or by other file transfer means that are known in the art.

In Step 510 the customer installs the autoload application 250 by executing an installation executable file. Once the autoload application 250 is installed, the customer is prompted to enter a user ID and password. In Step 520, the user ID and password are passed to the XML online tool 200 and are forwarded via the network 40 to the membership services application 210. In one embodiment, the membership services application 210 controls the granting of access rights to the customer. As part of the installation and configuration of the autoload application 250, the membership services application 210 requires that the customer agree to one or more license agreements relating to the use and access to the subscriber data. In Step 530, the customer agrees to the one or more access license agreements, and an access key is assigned to the customer. In one embodiment, the access key assigned to the customer is automatically embedded in all communications between the autoload application 250 and the customer. Alternatively, the customer may be prompted to re-enter the access key if the automated access application 250 is configured or re-configured.

In Step 540, the customer is prompted to configure the autoload application 250. In one embodiment, configuration options include the ability to one or more subscription names; to specify the file format (including but not limited to XML, flat file or comma separated value); a frequency of data updates (i.e. one or more days of the week and/or specified times on the scheduled days); and a target location where the files should be sent. In addition, the customer may specify the types of records to be automatically downloaded. In this way, the customer may customize the download to his or her specific needs. One of ordinary skill in the art will readily recognize that there are many ways to customize a file download scheduling application in accordance with the present invention.

In Step 550, once the autoload application 250 is installed and configured it automatically generates and submits the XML requests for the customer according to the schedule established by the customer. In this way, the customer receives automatic updates of its subscriber data without requiring that the customer manually submit XML requests using the XML online tool 200 or manually connect to and download subscriber data from a website. If the autoload application 250 encounters a problem while attempting to send the XML request and download the subscriber data an error message is displayed. In the event of a network problem, the autoload application 250 attempts to connect to the backend systems three or more times. And after the last attempt an error message is displayed if the autoload application 250 is still unable to connect. Also in an embodiment, the autoload application 250 compares the active status of each subscription identified by the customer, and returns only subscriber data from active subscriptions. If the autoload application 250 determines that one or more of the requested subscriptions is not active, the autoload application 250 returns an error code indicating the inactive status of the requested subscription. Similarly, in another embodiment, the autoload application 250 returns additional messages if a subscription status changes from an inactive or suspended status to an active status.

Proactive Notification Tool

Another aspect of the present invention is a notification system and method for proactive notification of a change in status of one or more packages. An embodiment of a system for proactive identification is shown in FIG. 19. In one embodiment, as shown in FIG. 19, a proactive notification tool 275 provides customers with the ability to request notification of key events in the progress of a package or shipment, including but not limited to: shipment, exception (delay), and delivery. Using the proactive notification tool 275, customers are notified proactively of any of these events and/or can request that notification be sent to others.

In contrast to the above-described systems, a proactive notification tool 275 uses package tracking numbers rather than customer reference numbers to identify the information to be captured. Unlike users of the above-described notification systems and methods, users of the proactive notification tool 275 do not require that the user obtain a service subscription. While the proactive notification tool 275 can operate as a fee-based service, the tool allows charges to be based on the notification services requested per package tracking number per request.

Notifications may be requested for one or more packages. In one embodiment, the types of notifications available to subscribing customers include ship notification, exception notification and delivery notification. Ship notification is an email notification message to one or more individuals informing the requestor's contact list that the carrier has received a package or shipment. Exception notification is an email notification message to one or more individuals when the scheduled day of delivery has changed such that the day of delivery is re-scheduled. Delivery notification is an email notification message to one or more individuals regarding the delivery, including date, time and name of recipient, of a package or shipment.

FIG. 19 illustrates a proactive notification tool 275 in accordance with an embodiment of the present invention. A customer communicates with a proactive notification engine 280 via the network 40. The notification engine 280 is separated into front-end and backend applications. In operation, the customer contacts the proactive notification front-end 285 via the network 40 using a web browser. The front-end application 285 allows the customer to request the proactive notification service and captures the information necessary to process the request (hereafter the notification request data). The front-end application 285 captures the notification request data from the customer and validates the data in the request. In one embodiment, the front-end application 285 prompts the customer to identify the package tracking number or numbers for which notification will be performed. For each of the requested package tracking numbers, the customer is asked to identify a type of notification requested (i.e. shipment, exception and/or delivery) and an email address (or other notification method known in the art) that will be used for notification purposes. In addition, if the proactive notification process is fee based, the front-end application 285 captures billing and/or payment information. In one embodiment, the billing process (i.e. the communication with billing and/or payment systems) is handled by the front-end application 285. In an alternative embodiment, the billing information is captured by the front-end application 285 and passed to the backend application 290, which handles the billing and/or payment processes.

The proactive notification backend application 290 receives the notification request data captured by the front-end application 285, and stores the data in a proactive notification database 295. On a periodic basis or on a scheduled specified by the customer, the backend application 290 queries one or more carrier tracking databases 60 with the package tracking number. Each time that a match occurs throughout the package life cycle, based on service, tracking number, and/or status change type, the backend application 290 creates an object for the notification email server 300. In one embodiment, the object is then passed to the notification email server 300 via a message queue or other messaging middleware that is known in the art. The notification email server 300 receives the object from the backend application 290 and extracts the notification data from the object. The data is then mapped to an appropriate proactive notification message and is sent to the email recipient (or recipients) specified in the object.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for tracking packages shipped via one or more carriers, comprised of:
a package visibility front-end that communicates with an interface over a network;
a visibility engine that communicates with said package visibility front-end, wherein said visibility engine is configured to capture user information from said interface, provide a tracking notification to one or more users, process user information and package-tracking information, and communicate with at least one of the carriers', a vendor's or said one or more user's systems;
one or more carrier databases and at least one of a subscription database or a package visibility database; wherein said subscription database is a database where at least user and account administration data is stored, said package visibility database is a storage area where at least information about inbound and outbound packages to said one or more users is stored, and said one or more carrier databases that store at least package level detail information about packages in transit, said package level detail information of certain one or more packages in transit including one or more universal identifiers (UIDs) that are each associated with an authorized entity; and
wherein said system receives at least one valid universal identifier via said interface as a portion of said user information and said system and provides at least a portion of said package level detail information about said certain one or more packages that are associated with said at least one valid universal identifier via said interface and said authorized entity associated with at least one universal identifier is not a shipper and not a recipient of the certain one or more packages.

2. The system of claim 1, wherein one or more of said account administration data, said information about inbound and outbound packages, and said package level detail information about said certain one or more packages associated with said at least one valid universal identifier may be added, deleted, modified or changed by the authorized entity assigned at least one universal identifier (UID).

3. The system of claim 1, wherein the interface is a user computer and the network is an Internet connection.

4. The system of claim 1, wherein the universal identifier is included in the package level detail information by matching a ship to or ship from address of the one or more packages with addresses associated with one-or more universal identifiers by use of an address matching system.

5. The system of claim 1, wherein the universal identifier is included in the package level detail information by a shipper of the one or more packages in information provided to the one or more carriers.

6. The system of claim 1, wherein the universal identifier is included in the package level detail information by an Internet cookie or certificate that identifies the universal identifier to the one or more carriers.

7. A system for tracking one or more packages comprised of:
an on-line transactions module accessible via an on-line transactions website via the Internet by one or more buyers and one or more sellers to conduct buy/sell transactions, wherein said buy/sell transactions comprise said sellers offering items for sale under a set of seller rules and said buyers may buy said items under a set of buyer rules and shipping transactions via one or more carriers for items sold by a buyer to a seller may be arranged through the on-line transactions website for a selected carrier;
a universal identification module, wherein shipping transactions that are arranged through the on-line transactions website have at least one unique universal identifier associated with the on-line transactions website that is assigned to package level detail information maintained by the selected carrier for each package shipped from the seller subsequent to said buy/sell transactions;
a tracking and reporting module, wherein each package shipped via the selected carrier and having the unique universal identifier is tracked and a status for each package is reported to an authorized operator of the on-line transactions website having knowledge of the unique universal identifier.

8. The system of claim 7, wherein the unique universal identifier is automatically included in each package's package level detail information by the selected carrier.

9. The system of claim 7, wherein the universal identifier is included in the package level detail information by matching a ship to or ship from address of the one or more packages with addresses associated with one or more universal identifiers by use of an address matching system.

10. The system of claim 7, wherein the universal identifier is included in the package level detail information by an Internet cookie or certificate that identifies the universal identifier to the selected carrier.

11. The system of claim 7, wherein the universal identifier is included in the package level detail information by a shipper of the one or more packages in information provided to the selected carrier.

12. The system of claim 7, wherein the on-line transactions website is an on-line marketplace website.

13. The system of claim 7, wherein the on-line transactions website in an on-line aggregator website.

14. A universal identifier used in the shipment of one or more packages via one or more carriers, said universal identifier comprised of:
a string of alphabetical, numeric, alphanumeric characters or symbols of varying length that may be encoded into a machine-readable format, wherein said universal identifier is included in package level detail information of one or more packages as such package level detail information is maintained by at least one of the one or more carriers transporting the one or more packages and where the universal identifier may be used to obtain at least a portion of the package level detail information about the one or more packages regardless of the location the one or more packages are shipped to or from, shippers of the one or more packages, or recipients of the one or more packages.

15. The universal identifier of claim 14, wherein the universal identifier is included in the package level detail information by matching a ship to or ship from address of the one or more packages with addresses associated with one or more universal identifiers by use of an address matching system.

16. The universal identifier of claim 14, wherein the universal identifier is included in the package level detail information by an Internet cookie or certificate that identifies the universal identifier to the at least one of the one or more carriers.

17. The universal identifier of claim 14, wherein the universal identifier is included in the package level detail information by the shippers of the one or more packages in information provided to the at least one of the one or more carriers.

18. The universal identifier of claim 14, wherein said universal identifier is used to access the package level detail information of the one or more packages and to add, modify, delete or change the package level detail information about the one or more packages.

19. A system for tracking packages having one or more universal identifiers, said system comprised of:
at least one carrier database, wherein the carrier database stores package information about one or more packages that are in transit in a carrier system, including the universal identifier associated with each package;
a visibility engine in communication with the carrier database, wherein the visibility engine is configured to review said package information and to identify the one or more packages having a certain universal identifier; and
a user computer in communication with said visibility engine via a network, wherein the user computer is configured to receive shipping information associated with the one or more packages having the certain universal identifier, including at least a portion of said package information.

20. The package tracking system of claim 19, wherein the certain universal identifier is assigned to shipping transactions involving the one or more packages shipped from a single shipping entity or multiple shipping entities to a single receiver entity or multiple receiver entities, said universal identifier provides access to information about the shipping transactions involving the single or multiple entities and said universal identifier is unrelated to the physical movement or location of the one or more packages, shipping entities or receiving entities.

21. The package tracking system of claim 19, wherein the universal identifier may be used for providing multiple visibility and shipment options to a third party, said third party is unrelated to the physical movement of the one or more packages in a supply chain.

22. The package tracking system of claim 19, wherein the universal identifier allows a third party to view, monitor and change business rules governing the physical movement transactions between multiple other shippers and recipient parties of the one or more packages.

23. The package tracking system of claim 19, wherein the universal identifier is used by the carrier to notify one or more certain parties of state changes of certain of the one or more packages, said certain parties being associated with the universal identifier.

24. The package tracking system of claim 23, wherein business rules of the certain parties provide for the certain parties to react to state changes of certain of the one or more packages by either no action, manually modifying the package information or business rules for delivery of the certain one or more packages, or automatically modifying the package information or business rules for delivery of the certain one or more packages, or any combination thereof.

25. The system of claim 19, wherein the universal identifier is included in the package level detail information by matching a ship to or ship from address of the one or more packages with addresses associated with one or more universal identifiers by use of an address matching system.

26. The system of claim 19, wherein the universal identifier is included in the package level detail information by an Internet cookie or certificate that identifies the universal identifier to the at least one of the one or more carriers.

27. The system of claim 19, wherein the universal identifier is included in the package level detail information by a shipper of the one or more packages in information provided to the one or more carriers.

28. A system that allows a first user to receive information about one or more packages that are inbound and outbound via one or more carriers from users other than the first user, said system comprised of:
a carrier database that stores shipping information for packages that are in transit in a carrier system;
a visibility engine in communication with the carrier database, wherein the visibility engine is configured to create an inbound subscription and an outbound subscription for the first user; and
a first user computer in communication with the visibility engine, wherein said visibility engine is configured to provide at least a portion of said shipping information for packages to the first user via the first user computer in accordance with the inbound or the outbound subscriptions.

29. The system of claim 28, wherein said inbound subscription specifies at least one universal identifier that is associated with the first user and said visibility engine is configured to identify packages that are inbound to users other than first user by comparing the at least one universal identifier against the shipping information, and said outbound subscription specifies the universal identifier associated with the first user, and said visibility engine is configured to identify packages that are outbound from users other than the first user by comparing the universal identifier against the shipping information, and said visibility engine is further configured to provide at least a portion of said shipping information for packages to the first user via the first user computer for packages inbound to and packages outbound from users other than the first user with a frequency specified in the inbound or the outbound subscriptions.

30. The system of claim 28, wherein the inbound subscription specifies at least one universal identifier that is associated with the first user, and wherein the visibility engine is configured to identify packages that are inbound to the first user and one or more other users by comparing the at least one universal identifier against the shipping information and said outbound subscription specifies the universal identifier associated with the first user and said visibility engine is configured to identify packages that are outbound from the first user and the one or more other users by comparing the universal identifier against the shipping information, and said visibility engine is further configured to provide at least a portion of the shipping information for packages to the first user via the first user computer for packages inbound to and packages outbound from the first user and the one or more other users in a format specified in the inbound or the outbound subscriptions.

31. The system of claim 28, wherein the inbound and outbound subscription specifies at least one universal identifier that is associated with the first user and said visibility engine is configured to identify packages that are inbound to and outbound from the first user by comparing the at least one universal identifier against the shipping information, and said visibility engine is further configured to provide at least a portion of the shipping information for packages to the first user via the first user computer for packages inbound to and packages outbound from the first user with a frequency specified in the inbound and outbound subscription.

32. The system of claim 28, wherein the inbound and outbound subscription specifies a master universal identifier and at least one universal identifier that is in a hierarchical relation to the master universal identifier, said master universal identifier and the at least one universal identifier are associated with the first user and the visibility engine is configured to identify packages that are inbound to and outbound from the first user by comparing the master universal identifier and the at least one universal identifier against the shipping information, said visibility engine is further configured to provide at least a portion of the shipping information for packages to the first user via the first user computer for packages inbound to and packages outbound from the first user with such information sorted by the at least one universal identifier and with a frequency specified in the subscription.

33. The system of claim 28, wherein the inbound and outbound subscription specifies a master universal identifier and a plurality of universal identifiers that are each in a hierarchical relation to the master universal identifier, said master universal identifier and the plurality of universal identifiers are associated with the first user and the visibility engine is configured to identify packages that are inbound to and outbound from the first user by comparing the master universal identifier and the plurality of universal identifiers against the shipping information, said visibility engine is further configured to provide at least a portion of the shipping information for packages to the first user via the first user computer for packages inbound to and packages outbound from the first user with such information sorted by the plurality of universal identifiers and with a frequency specified in the subscription.
